(19) United States
(12) Patent Application Publication
(10) Pub. No.: US 2025/0293733 A1
(43) Pub. Date: Sep. 18, 2025

(54) METHODS, ARCHITECTURES, APPARATUSES AND SYSTEMS FOR ENHANCEMENTS FOR WTRUs WITH MULTIPLE ANTENNAS

(71) Applicant: InterDigital Patent Holdings, Inc., Wilmington, DE (US)

(72) Inventors: Afshin Haghighat, lle-Bizard (CA); Loic Canonne-Velasquez, Dorval (CA); Jonghyun Park, Syosset, NY (US); Moon IL Lee, Melville, NY (US)

(21) Appl. No.: 18/860,426

(22) PCT Filed: Apr. 24, 2023
(86) PCT No.: PCT/US2023/019619

§ 371 Date: Oct. 25, 2024

Related U.S. Application Data
(60) Provisional application No. 63/334,927, filed on Apr. 26, 2022.
(60) Provisional application No. 63/395,953, filed on Aug. 8, 2022.
(60) Provisional application No. 63/445,674, filed on Feb. 14, 2023.

(51) Int. Cl. H04B 7/0456; H01Q 21/24

(52) U.S. Cl. CPC H04B 7/0456; H01Q 21/24

(57) ABSTRACT

A method implemented in a WTRU is described herein. The method may include transmitting capability information indicating a number of antenna groups and receiving configuration information indicating one codebook or more than one codebook. The method may include receiving scheduling information for a transmission. The scheduling information may indicate (a) a codebook indicator and one transmit precoding matrix indicator (TPMI) or (b) a plurality of TPMIs. Each TPMI may be associated with a group of antennas. The method may include determining a codebook of the one codebook or the more than one codebook based on any of the scheduling information and the configuration information. The method may include transmitting the transmission based on the determined codebook and (a) the one TPMI or (b) the plurality of TPMIs.

### CROSS-REFERENCE TO RELATED APPLICATIONS

This application claims the benefit of US Patent Application Nos. 63/334,927 filed Apr. 26, 2022, 63/395,953 filed Aug. 8, 2022, and 63/445,674 filed Feb. 14, 2023, each of which is incorporated herein by reference in its entirety.

### TECHNICAL FIELD

The present disclosure is generally directed to the fields of communications, software and encoding, including, for example, to methods, architectures, apparatuses, systems directed to enhancements for wireless transmit/receive units (WTRUs) with multiple transmission (Tx) antennas.

### BACKGROUND

According to new radio (NR) Release 17, a WTRU may support an uplink transmission with up to four-layer transmission (e.g., including four transmission ports, four power amplifiers) and a single code word transmission. Embodiments described herein have been designed with the foregoing in mind.

### BRIEF SUMMARY

Methods, architectures, apparatuses, and systems directed to wireless transmit/receive units (WTRUs) with multiple transmission (Tx) antennas are described herein. In an embodiment, a first method implemented in a WTRU is described herein. The first method may include transmitting capability information indicating a number of antenna groups and receiving configuration information indicating one codebook or more than one codebook. The first method may include receiving scheduling information for a transmission. In various embodiments, the scheduling information may indicate (a) a codebook indicator and one transmit precoding matrix indicator (TPMI) or (b) a plurality of TPMIs. In various embodiments, each TPMI may be associated with an antenna group. The first method may include determining a codebook of the one codebook or the more than one codebook based on any of the scheduling information and the configuration information. The first method may include transmitting the transmission based on the determined codebook and (a) the one TPMI or (b) the plurality of TPMIs.

In an embodiment, a second method implemented in a WTRU is described herein. The second method may include transmitting capability information indicating a single antenna group and receiving configuration information indicating more than one codebook. The second method may include receiving scheduling information for a transmission. In various embodiments, the scheduling information may indicate a codebook of the more than one codebook and a transmit precoding matrix indicator (TPMI). The second method may include transmitting the transmission based on the indicated codebook and the indicated TPMI.

In an embodiment, a third method implemented in a WTRU is described herein. The third method may include transmitting capability information indicating a number of antenna groups and receiving configuration information indicating a codebook. The third method may include receiving scheduling information for a transmission. In various embodiments, the scheduling information may indicate a plurality of transmit precoding matrix indicators (TPMIs). In various embodiments, each TPMI may be associated with an antenna group. The third method may include transmitting the transmission based on the indicated codebook and the indicated plurality of TPMIs.

In an embodiment, a WTRU including a processor and a transmitter and a receiver (e.g., a transceiver) operatively coupled to the processor is described herein. The processor may be configured to carry out any of the first method, the second method and the third method.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 is a diagram illustrating an example of transmit processing chain in a WTRU;

FIG. 3 is a diagram illustrating examples of antenna configurations that may be used to support up to 8Tx transmission;

FIG. 4 is a diagram illustrating an example method for codebook determination;

FIG. 5 is a diagram illustrating an example method for uplink codebook and precoding determination based on WTRU antenna layout;

FIG. 6 is a diagram illustrating an example method for codebook determination;

FIG. 7 is a diagram illustrating an example method for codebook and precoding determination by a WTRU based on a number of antenna groups;

FIG. 8 is a diagram illustrating an example method for codebook and precoding determination by a WTRU with a single antenna group;

FIG. 9 is a diagram illustrating an example method for codebook and precoding determination by a WTRU with more than one antenna group;

FIG. 10 is a diagram illustrating an example method for determining precoding information and transmission rank information based on receiving configuration information in separate transmissions;

FIG. 11 is a diagram illustrating an example method for reducing the channel state information overhead for WTRUs with multiple sets of transmit antennas; and

FIG. 12 is a diagram illustrating an example method for enabling a dynamic transmit antenna configuration.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

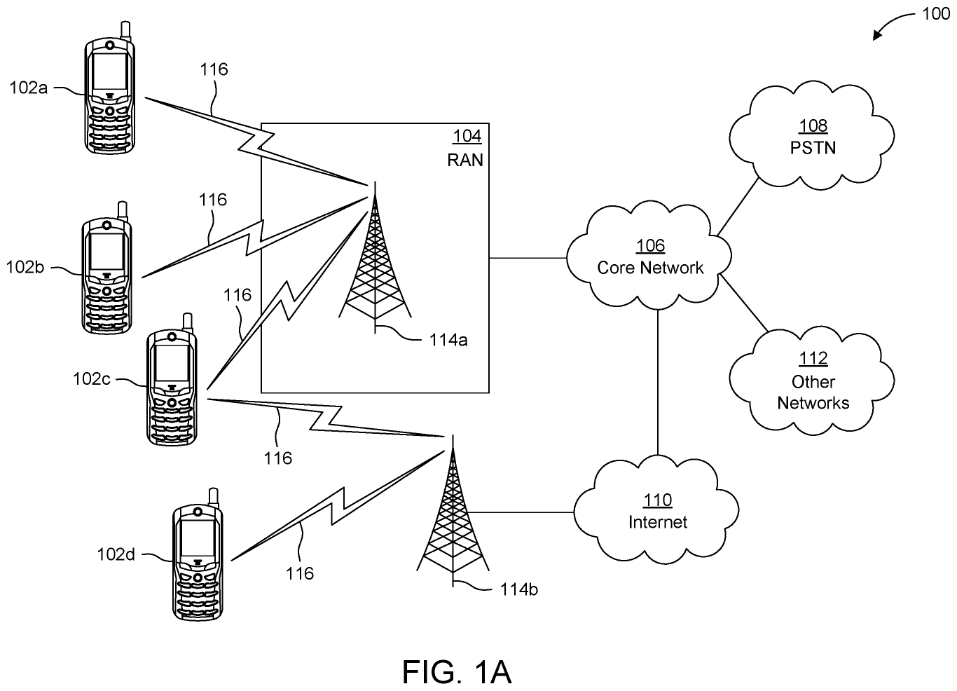

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discrete Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general-purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134 and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.1 lac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Throughout embodiments described herein the terms “base station”, “network”, and “gNB”, collectively “the network” may be used interchangeably to designate any network element such as e.g., a network element acting as a serving base station. Embodiments described herein are not limited to gNBs and are applicable to any other type of base stations.

Throughout embodiments described herein, (e.g., configuration) information may be described as received by a WTRU from the network, for example, through system information or via any kind of protocol message. Although not explicitly mentioned throughout embodiments described herein, the same (e.g., configuration) information may be pre-configured in the WTRU (e.g., via any kind of pre-configuration methods such as e.g., via factory settings), such that this (e.g., configuration) information may be used by the WTRU without being received from the network.

Throughout embodiments described herein the terms “grant information”, “downlink control information (DCI)”, and “scheduling information” may be used interchangeably to designate information indicating scheduling of a (e.g., upcoming) transmission. Embodiments described herein are not limited to DCI indicating scheduling of a transmission and any other types of information indicating scheduling of a transmission may be applicable to embodiments described herein.

Throughout embodiments described herein the terms “subset of antenna”, “antenna subset”, “group antenna” and “antenna group” may be used interchangeably.

For the sake of simplicity, embodiments are described herein for a scheduled uplink transmission (such as e.g., a physical uplink shared channel (PUSCH) transmission). Embodiments described herein are not limited to a scheduled uplink transmission and may be applicable to any other type of scheduled transmission that may be performed by a WTRU, such as, for example, a (e.g., scheduled) sidelink transmission.

### Example of Transmit Processing Chain

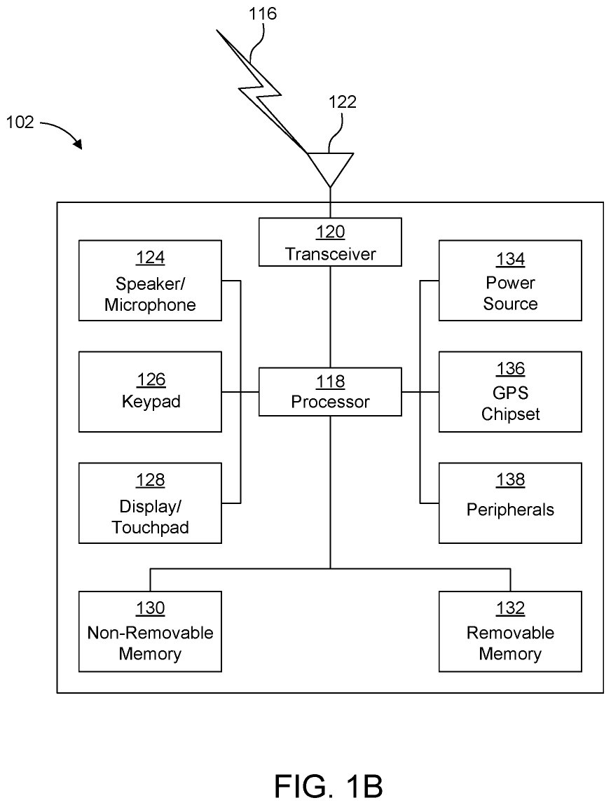

FIG. 2 is a diagram illustrating an example of transmit processing chain in a WTRU. As shown at 21, the process may start with applying forward error correction coding and cyclic redundancy check (CRC) attachment. For example, the process may produce at least one codeword at a time. The coded bit sequence may be scrambled and modulated according to, for example, the configured modulation format, such as e.g., any of quadrature phase-shift keying (QPSK), 16 quadrature amplitude modulation (QAM), etc. In a WTRU with multiple transmitter antennas, the sequence of modulated symbols may be mapped to a number of parallel layers as shown at 22. The produced layers may be pre-coded according to the condition of the wireless channel as shown at 23 and mapped to their corresponding antenna ports as shown at 24. As shown at 25, (e.g., proper) waveforms may be generated and transmitted over the air according to a set power by power control as shown at 26. For a (e.g., each) transmission, e.g., in parallel to the above process, one or more reference signals may be generated, and mapped along with the modulated data symbols, as shown at 20.

According to the Release 17 NR specification, a WTRU may support (e.g., perform) an uplink transmission with the following capabilities:
Up to 4-layer transmission,
4 transmission ports,
4 power amplifiers (Pas),
Single codeword transmission,
DFT-s-OFDM and conventional OFDM (relying on cyclic prefix CP-OFDM).

In Release 18 MIMO, to enhance coverage, reliability, and throughput, for e.g., categories of WTRUs, enhancements for uplink transmission may be considered. For example, in NR Rel-18 any of uplink demodulation reference signal (UL DMRS), sounding reference signal (SRS), SRS resource indicator (SRI), and transmit precoding matrix indication (TPMI) e.g., including codebook may be enhanced to enable 8 Tx UL operation to support 4 and more layers per WTRU in UL targeting any of customer premises equipment (CPE), fixed wireless access (FWA), vehicle and industrial devices. In NR rel-17, a WTRU may receive information indicating a TPMI in a scheduling DCI and may use it to determine the precoding matrix for the transmission.

For example, WTRUs configured for 8Tx operation may have higher power rating than power class 3 (PC3), and a wider range of PA ratings, for example,

| | |
|---|---|
| FR2 for FWA: | EIRPmin = 40 to 55 dBm per band |
| FR2 for VEH (PC2): | EIRPmin = 29 to 43 dBm per band |
| FR2 for HP-non-handheld/industrial | EIRPmin = 34 to 43 dBm per band |
| (PC4): | |

### Overview

Methods for codeword layer mapping measurements for 8Tx WTRUs are described herein. For example, different examples for layer mapping for single codeword and two codewords are described herein.

Methods for precoding codebook determination and indication for 8Tx WTRUs are described herein. For example, different examples for codebook determination are described herein considering different potential WTRU Tx architecture that may not be disclosed (e.g., indicated) by WTRU vendors (e.g., manufacturers).

Methods for channel state information (CSI) indication and overhead management for 8Tx WTRUs are described herein. For example, embodiments described herein may allow to exploit the (e.g., relative) static nature of the 8Tx WTRUs to reduce the downlink control information (DCI) overhead.

Methods for power control for 8Tx WTRUs are described herein. For example, embodiments described herein may allow to support full power mode.

Throughout embodiments described herein, the terms “antenna panel”, “antenna group” and “antenna port group” may be used interchangeably.

### Examples of Procedures for Codeword Layer Mapping Measurements

In NR Release 17, the layer mapping for downlink transmission may be based on any of a single and a dual codeword transmission. For example, for uplink transmission the codeword to layer mapping may be defined for a single codeword transmission. For WTRUs with more than one antenna, both single and dual codeword may be used.

### Example of Single Codeword Operation

In an embodiment, a WTRU may use an arbitrary order for mapping the modulated symbols of a codeword to the (e.g., configured) number of layers. For example, a WTRU may start the mapping process by assigning modulated symbols d⁽⁰⁾'s to layers x^{(k)}'s in a sequential basis. For example, for any of 6 and 8 Tx antennas, layer to codeword mappings may be defined as,

| | |
|---|---|
| 6Tx: | 8Tx: |
| x⁽⁰⁾(i) = d⁽⁰⁾(6i), | x⁽⁰⁾(i) = d⁽⁰⁾(8i), |
| x⁽¹⁾(i) = d⁽⁰⁾(6i + 1), | x⁽¹⁾(i) = d⁽⁰⁾(8i + 1), |
| x⁽²⁾(i) = d⁽⁰⁾(6i + 2), | x⁽²⁾(i) = d⁽⁰⁾(8i + 2), |
| x⁽³⁾(i) = d⁽⁰⁾(6i +3), | x⁽³⁾(i) = d⁽⁰⁾(8i + 3), |
| x⁽⁴⁾(i) = d⁽⁰⁾(6i + 4), | x⁽⁴⁾(i) = d⁽⁰⁾(8i + 4), |
| x⁽⁵⁾(i) = d⁽⁰⁾(6i + 5) | x⁽⁵⁾(i) = d⁽⁰⁾(8i + 5), |
| | x⁽⁶⁾(i) = d⁽⁰⁾(8i + 6), |
| | x⁽⁷⁾(i) = d⁽⁰⁾(8i + 7) |

where i=1, 2, . . . , M_{symb}^{layer} and M_{symb}^{layer} may be referred to herein as the number of modulation symbols per layer.

In an embodiment, a WTRU may apply a different permutation of modulated symbols for layer mapping where the order may be changed from time to time. A benefit of an inter-layer randomization may be to balance potential differences in signal quality across the layers. For example, a WTRU may apply an inter-layer randomization as part of codeword to layer mapping. For example, the inter-layer (e.g., randomization, permutation) function may follow a predefined function, such as e.g., any of a periodic function, pseudo-random, etc. For example, an inter-layer randomizer may be characterized by (e.g., associated with) a parameter set P that may represent (e.g., include) one or more parameters, such as e.g., any of a seed, a period, etc.

In an embodiment, to assist the gNB to correctly reconstruct the order of transmitted symbols for demodulation, descrambling, and decoding, parameter set P may be known to gNB.

In a first example, a WTRU may send information indicating the parameter set P to gNB where the information may be transmitted by another transmission, such as e.g., any of an earlier transmission, a transmission on another channel (e.g., physical uplink control channel (PUCCH)), etc.

In a second example, a WTRU may receive information indicating the parameter set P through any of an implicit and an explicit indication by gNB.

For example, a WTRU may detect (e.g., determine) the parameter set P by a dynamic indication, e.g., a scheduling DCI. The received indication may be explicit, e.g., explicit received information indicating a received index, etc. In another example, the received indication may be implicit, e.g., based on the index of any of the lowest scheduled resource block (RB) for the transmission, hybrid automatic repeat request identifier (HARQ ID), redundancy version (RV), etc.

In another example, a WTRU may determine the parameter set P based on one or more system parameters, such as e.g., any of a cell index, a frame number, a slot number, a cell radio network temporary identifier (C-RNTI), a synchronization signal block resource indicator (SSBRI), etc.

For example, for a WTRU with 8 Tx, a random inter-layer randomization may be processed as follows:

8Tx:
x⁽⁰⁾(i) = d⁽⁰⁾(8i + mod(p, 8)),
x⁽¹⁾(i) = d⁽⁰⁾(8i + mod(p + 1, 8)),
x⁽²⁾(i) = d⁽⁰⁾(8i + mod(p + 2, 8)),
x⁽³⁾(i) = d⁽⁰⁾(8i + mod(p + 3, 8)),
x⁽⁴⁾(i) = d⁽⁰⁾(8i + mod(p + 4, 8)),
x⁽⁵⁾(i) = d⁽⁰⁾(8i + mod(p + 5, 8)),
x⁽⁶⁾(i) = d⁽⁰⁾(8i + mod(p + 6, 8)),
x⁽⁷⁾(i) = d⁽⁰⁾(8i + mod(p + 7, 8))

Where p may be based on any of a cell index, a frame number, a slot number, a C-RNTI, SSBRI, an index of the lowest scheduled RB for the transmission, an HARQ ID, an RV, etc., and where “mod” represents a modulo function.

### Example of Dual Codeword Operation

In an embodiment, a WTRU may re-use the same codeword to layer mapping as used in NR Rel-17 for downlink transmission. In a case where a WTRU uses dual codeword for an uplink transmission, uplink scheduling DCIs, e.g., DCI Formats 0_0, 0_1, 0_2 may be enhanced (e.g., extended). In NR Rel-17 following DCI information (e.g., fields) may be available as part of a scheduling configuration that may be relevant for (e.g., applicable to) operation of a single codeword transmission:
MCS information: modulation-and-coding scheme indicating modulation, code rate and transport-block size, e.g., 5 bits.
NDI information: new data indicator indicating whether the scheduled grant may be related to a new transmission or a re-transmission, e.g., 1 bit.
RV information: redundancy version indicating the redundancy version for a scheduled transmission, e.g., 2 bits.
UL-SCH information: indicating that the grant may be to be used for physical uplink shared channel (PUSCH) or physical uplink control channel (PUCCH), e.g., 1 bit.
Priority indication information: indicating a priority of the scheduled transmission, e.g., ultra-reliable low latency communication (URLLC) or not, if configured, e.g., 1 bit.
Hybrid-ARQ process number information: indicating the hybrid-ARQ process number for the scheduled (re)transmission, e.g., 4 bits.
DAI information: downlink assignment index.
CBGTI information: code block group transmission indicator indicating code block groups for retransmission, e.g., 6 bits.
   In an embodiment, a WTRU may receive (e.g., enhanced) DCI information with (e.g., including, indicating) one or more of the following enhancements for operation with more than one codeword for uplink transmission. For example, (e.g., enhanced) DCI information may include per codeword indications and/or single based indications.

In a first example of per codeword indications, (e.g., enhanced) DCI information may include two new data indicator (NDI) information elements indicating NDI independently for a (e.g., each) codeword, e.g., 2 bits. For example, a first NDI information element may indicate a new data indicator for a first codeword and a second NDI information element may indicate a new data indicator for a second codeword.

In a second example of per codeword indications, (e.g., enhanced) DCI information may include two RV information elements indicating RV independently for a (e.g., each) codeword, e.g., 4 bits. For example, a first RV information element may indicate a redundancy version for a first codeword and a second RV information element may indicate a redundancy version for a second codeword.

In a third example of per codeword indications, (e.g., enhanced) DCI information may include two UL-SCH information elements separately indicating eligibility UL-SCH for use of the grant, e.g., 2 bits.

In a third example of per codeword indications, (e.g., enhanced) DCI information may include two Hybrid-ARQ process number information elements indicating a Hybrid-ARQ process number per codeword, e.g., 8 bits.

In a fourth example of per codeword indications, (e.g., enhanced) DCI information may include two code block group transmission indicator (CBGTI) information elements indicating CBG transmission order per codeword, e.g., 12 bits.

In a first example of single-based indication, (e.g., enhanced) DCI information may include a single modulation and coding scheme (MCS) information element indicating (e.g., determining) a modulation-and-coding scheme for both codewords, e.g., 5 bits.

In a second example of single-based indication, (e.g., enhanced) DCI information may include a single priority indication information element indicating priority of the scheduled transmission, e.g., 1 bit.

In a third example of single-based indication, (e.g., enhanced) DCI information may include a single DAI information element indicating a downlink assignment index.

For example, in a single codeword uplink transmission, a WTRU may receive information indicating a single TPMI and SRI values to select any of the precoding matrix and the number of layers for uplink transmission, and to indicate any of the antenna ports and the beam (e.g., to be used) for the scheduled uplink transmission, respectively.

For example, a WTRU may receive information indicating more than one TPMI where e.g., a first TPMI may be used for precoding the first codeword, and a second TPMI may be used for precoding a second codeword. For example, a WTRU may receive information indicating more than one SRI where e.g., a first SRI may be used to indicate a beam related to (e.g., associated with) a transmission of a first codeword, and a second SRI may be used to indicate a beam related to (e.g., associated with) a transmission of a second codeword.

### Example of Determination of the Number of Codeword

For example, for a UL transmission, the number of codewords (CWs) may be determined based on the number of layers determined, wherein the number of layers may be referred to as a transmission rank. For example, in a case where the transmission rank is 3 (e.g., R=3), the number of layers used for a UL transmission may be 3.

In an embodiment, for a (e.g., given) transmission rank that may be determined for a UL transmission, the number of codewords may be determined based on any of (i) a WTRU coherence capability, (ii) a number of antenna panels that may be simultaneously used for an UL transmission, (iii) a codebook subset that may be any of used and configured, and (iv) a mode of operation (e.g., single transmission reception point (TRP) or multi-TRP)

In a first example, for a (e.g., given) transmission rank that may be determined for a UL transmission, the number of codewords may be determined based on a WTRU coherence capability. For example, one or more WTRU coherence capabilities may be used, and one of the one or more WTRU coherence capabilities may be any of indicated (e.g., by information received by the WTRU), reported (e.g., indicated in information transmitted by the WTRU), and determined by the WTRU, wherein WTRU coherence capabilities may be referred to as WTRU transmit antenna coherence capability. For example, the WTRU coherence capability may include any of “nonCoherent”, “partialAndNonCoherent”, and “fullyAndPartialAndNonCoherent”. For example, in a case where a WTRU transmits information indicating a first WTRU coherence capability (e.g., “fullyAndPartialAndNonCoherent”), a first number of CWs (e.g., 1 CW) may be used for a (e.g., given) transmission rank (e.g., R=5). For example, in a case where a WTRU transmits information indicating a second WTRU coherence capability (e.g., “nonCoherent”), a second number of CWs (e.g., 2 CWs) may be used for a (e.g., given) transmission rank (e.g., R=5).

In a second example, for a (e.g., given) transmission rank that may be determined for a UL transmission, the number of codewords may be determined based on a number of antenna panels that may be simultaneously used for a UL transmission. For example, in a case where a WTRU uses a single antenna panel for an UL transmission with a (e.g., given) transmission rank (e.g., R=5), a first number of CWs (e.g., 1 CW) may be used for the UL transmission. For example, in a case where a WTRU uses more than one antenna panel for an UL transmission with the (e.g., given) transmission rank (e.g., R=5), a second number of CWs (e.g., 2 CWs) may be used for the UL transmission. For example, information indicating the number of antenna panels used for an UL transmission with a given transmission rank may be transmitted (e.g., reported) by the WTRU, wherein the information may indicate any of (i) the number of antenna panels used for a (e.g., each) transmission rank, (ii) a (e.g., preferred) number of CWs for a (e.g., each) transmission rank and a group-based antenna coherence indication (e.g., indicating how many antenna groups which may be fully coherent).

In a third example, for a (e.g., given) transmission rank that may be determined for an UL transmission, the number of codewords may be determined based on codebook subset that may be any of used and configured. For example, one or more codebook subsets may be used. For example, a WTRU may be configured to use one of the codebook subsets for an UL transmission, wherein a (e.g., each) codebook subset may be associated with a number of CWs to use for an UL transmission. For example, the codebook subset may be configured via any of a higher layer signaling per WTRU (e.g., where the WTRU may receive configuration information indicating the codebook subset), bandwidth part (BWP), carrier, frequency band (e.g., FR1, FR2), and cell. For example, the codebook subset may be dynamically indicated for a (e.g., each) UL transmission via a received L1 signaling information (e.g., a DCI for UL grant may include information indicating the codebook subset). For example, the codebook subset may be implicitly determined based on the WTRU coherence capability that may be any of indicated and reported.

In a fourth example, for a (e.g., given) transmission rank that may be determined for an UL transmission, the number of codewords may be determined based on a mode of operation (e.g., single TRP or multi-TRP). For example, one or more modes of operation may be used for a UL transmission (e.g., based on the number of TRPs involved). For example, the number of CWs to use for an UL transmission may be determined by a WTRU based on which mode of operation may be used. For example, a single CW (e.g., 1 CW) may be used in a case where a WTRU is configured or operated with a single TRP mode of operation. For example, in a case where a WTRU is configured or operated with multi-TRP mode of operation, more than one CW (e.g., 2 CWs) may be used. For example, the mode of operation may be determined or indicated (e.g., by configuration information that may be received) based on the number of CORESETPoolId that may be configured for physical downlink control channel (PDCCH) monitoring.

For example, the number of codewords may be interchangeably used with codeword to layer mapping. For example, in a case where two CWs are used for an UL transmission, a first CW-to-layer mapping may be used for a (e.g., given) rank if a WTRU is configured with a first codebook subset, and a second CW-to-layer mapping may be used for a (e.g., given) rank if the WTRU is configured with a second codebook subset.

In an example, for R=3, a first CW may map to (e.g., be associated with) a first and a second layers and a second CW may map to (e.g., be associated with) a third layer in a case where a first codebook subset is configured for the WTRU. Otherwise, the first CW may map to (e.g., be associated with) the first layer and the second CW may map to (e.g., be associated with) the second and third layers.

Table 1 shows an example of CW-to-layer mapping (e.g., associations) based on condition. For example, condition #1 and #2 may be determined based on any of (i) the WTRU coherence capability, (ii) the number of antenna panels that may be simultaneously used for an UL transmission, (iii) the codebook subset that may be any of used and configured, and (iv) the mode of operation.

TABLE 1
Example of CW-to-layer mapping for
a Tx Rank based on conditions.

| Tx | Condition #1 | | Condition #2 | |
|---|---|---|---|---|
| Rank | 1^{st} CW | 2^{nd} CW | 1^{st} CW | 2^{nd} CW |
| 3 | Layer {1, 2} | Layer {3} | Layer {1} | Layer {2, 3} |
| 4 | Layer {1, 2} | Layer {3, 4} | Layer {1, 2, 3} | Layer {4} |
| 5 | Layer {1, 2, 3} | Layer {4, 5} | Layer {1, 2} | Layer {3, 4, 5} |
| 6 | Layer {1, 2, 3} | Layer {4, 5, 6} | Layer {1, 2} | Layer {3, 4, 5, |
| | | | | 6} |

In an embodiment, the number of layers for a (e.g., each) CW may be determined based on the transmission rank indicated for each TRP. For example, in a case where an UL transmission is used for multi-TRP, a (e.g., each) TRP may transmit information indicating a transmission rank for an UL transmission and the total UL transmission rank may be determined based on the aggregated number of transmission ranks indicated from one or more TRPs.

### Example of Precoding Codebook Determination and Indication

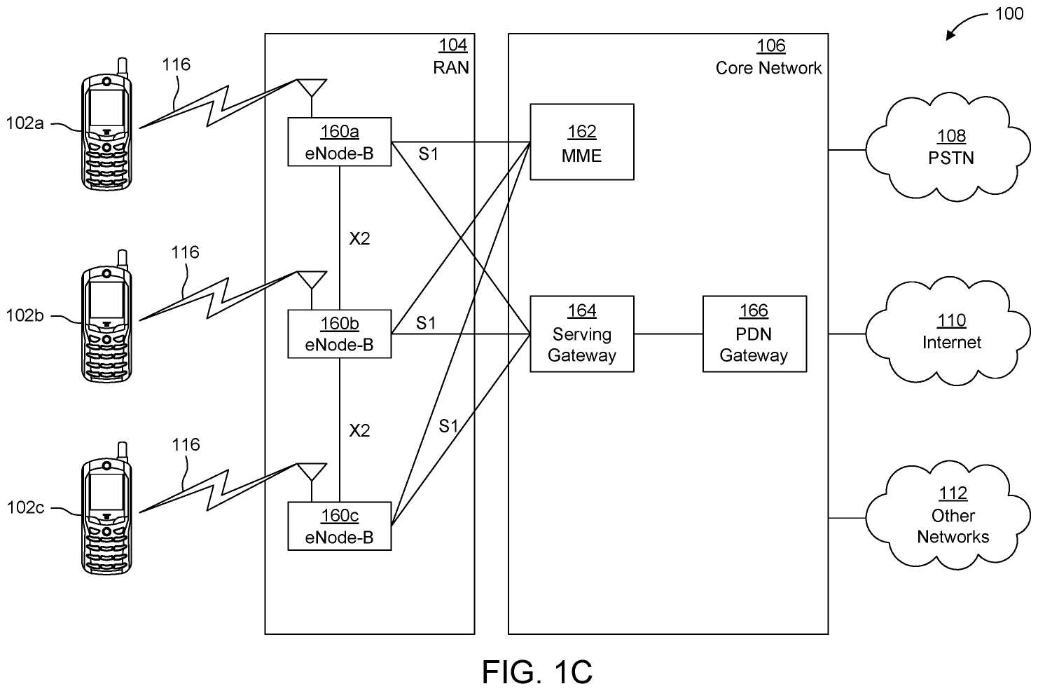

FIG. 3 is a diagram illustrating examples 31, 32, 33 of antenna configurations that may be used to support up to 8Tx transmission. For example, based on any of its RF structure its capability reporting, virtualization capability, etc., a WTRU may support one or more codebooks for uplink precoding. For example, based on its reported (e.g., transmitted) capability (e.g., information), a WTRU may receive information indicating to use a specific codebook for TPMI.

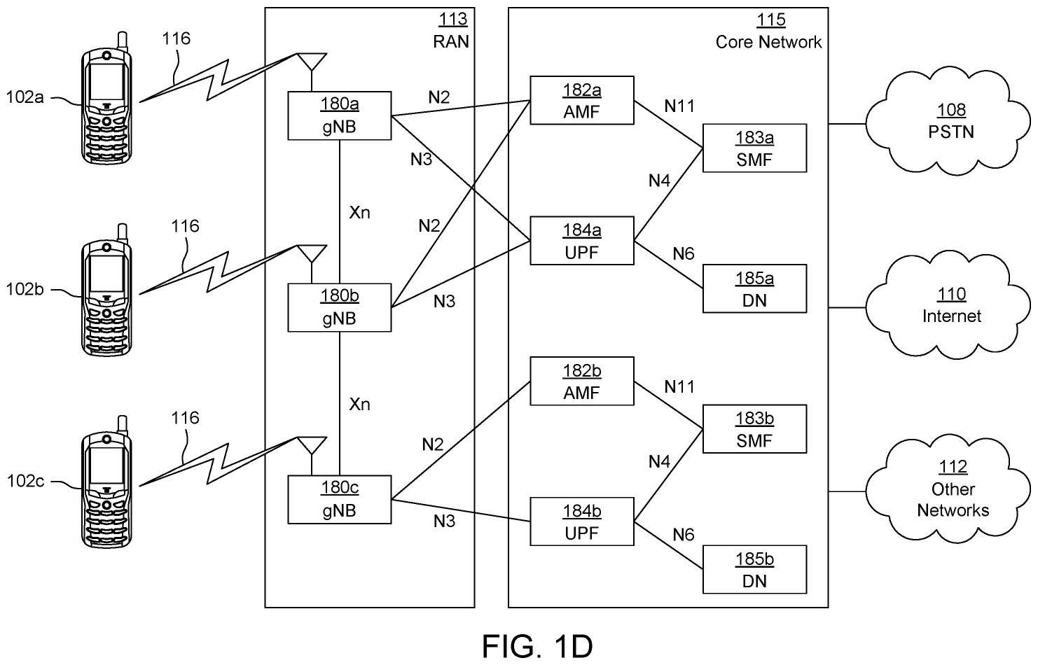

FIG. 4 is a diagram illustrating an example method for codebook determination and interpretation of TPMI. For example, a WTRU may send first information 41 to assist the gNB for configuration of the uplink codebook. For example, the first information 41 may indicate any of a coherency capability, a virtualization capability, an antenna (e.g., panel) configuration, a power rating (e.g., capability), etc. For example, the WTRU may receive second information 42 indicating one or more (e.g., valid) codebooks, e.g., to be used for an UL transmission. For example, the WTRU may receive third information 43 (e.g., a scheduling DCI) including a TPMI information. The third information 43 may indicate to activate one of the valid codebooks. For example, the WTRU may interpret the TPMI according to the activated codebook and may use it to transmit an uplink transmission 44, e.g., in the physical uplink shared channel (PUSCH).

### Example of Antenna Structure-Based Precoding Codebook Determination

For example, a WTRU may transmit information indicating its (e.g., general) antenna structure to be used by the gNB for proper selection and configuration of a codebook. For example, a WTRU may transmit information indicating whether its antenna structure may be based on a cross-polarized array (e.g., “a)” in FIG. 3), an array of uniform linear array (e.g., “b)” in FIG. 3), or a single uniform line array (e.g., “c)” in FIG. 3), etc. For example, the WTRU may transmit information indicating the number of antennas, panels, etc.

In an embodiment, a WTRU may transmit information indicating one or more (e.g., capability) parameters for representing (e.g., reflecting, indicating) the WTRU antenna (e.g., panel) structure (such as e.g., a basic antenna (e.g., panel) structure) that may be used for determining one or more UL-codebooks of a plurality of UL-codebooks for uplink transmissions. For example, the plurality of UL-codebooks may be any of pre-defined, pre-determined, pre-configured in the WTRU, and indicated by configuration information that may be received by the WTRU.

In a first example, the one or more capability parameters may indicate a number of dimension(s) (which may be referred to herein as D) for a UL precoder generation that may be supported (e.g., implemented) by the WTRU.

In a case where, for example, the number of dimension(s) (e.g., being reported) is one, any of a UL codebook and corresponding TPMI index(es) based on one (e.g., single) dimension for a precoder generation, (such as e.g., any of “b)” or “c)” in FIG. 3), any of a non-Kronecker type of codebook, a linear type of codebook, etc., may be determined (e.g., constructed, configured, indicated, used) for the WTRU. For example, the gNB may transmit information indicating any of a non-Kronecker type of codebook and a linear type of codebook to be used by the WTRU.

In a case where, for example, the number of dimension(s) (e.g., being reported) is two, any of a UL codebook and corresponding TPMI index(es) based on availability of two dimensions for a precoder generation, such as e.g., “a)” in FIG. 3, a Kronecker type of codebook comprising at least two dimensions such as a horizontal component and a vertical component, etc., may be determined (e.g., constructed, configured, indicated, used) for the WTRU. For example, the gNB may transmit information indicating the determined Kronecker type of codebook (e.g., comprising at least two dimensions such as a horizontal component and a vertical component) to be used by the WTRU.

In a case where, for example, the number of dimension(s) (e.g., being reported) is greater than or equal to two, any of a UL codebook and corresponding TPMI index(es) based on availability of at least two dimensions for a precoder generation may be determined (e.g., constructed, configured, indicated, used) for the WTRU.

For example, for any number of dimension(s), a UL precoder (e.g., corresponding to a TPMI index) may be determined (e.g., constructed) based on a function of D components, (e.g., each) representing a separate beam (e.g., precoder-domain).

For example, for any number of dimension(s), a UL precoder (e.g., corresponding to more than one TPMI index) may be determined (e.g., constructed) based on a function of D components, (e.g., each) representing a separate beam (e.g., precoder-domain), and based on one or more mappings (e.g., associations) between one TPMI index and a subset of the D components. For example, the more than one TPMI index associated with the UL precoder may be indicated by information received by the WTRU in a case where UL grant information indicating an UL grant is received. For example, the one or more mappings (e.g., associations) between one TPMI index and a subset of the D components may be any of pre-configured, pre-defined, determined, and indicated by configuration information received by the WTRU.

In a second example, the one or more capability parameters may indicate a number of WTRU panel(s) (which may be referred to herein as P) that may be supported (e.g., implemented) by the WTRU. For the sake of clarity, embodiments are described herein with a number of WTRU panels (P) that may be up to P=2. A number of more than two WTRU panels (e.g., P>2) may be applicable to embodiments described herein.

In a case where the WTRU comprises one panel, (e.g., if P e.g., being reported is equal to one), any of a UL codebook and corresponding TPMI index(es), based on no (e.g., particular) beam (e.g., precoder-domain) distance (e.g., gap), may be determined (e.g., constructed, configured, indicated, used) for the WTRU. For example, the gNB may transmit information indicating the determined UL codebook and corresponding TPMI index(es).

In a case where the WTRU comprises more than one panel, (e.g., if P e.g., being reported is greater than or equal to two), any of a UL codebook and corresponding TPMI index(es) may be determined (e.g., constructed, configured, indicated, used) based on availability of two WTRU-panels for the WTRU for communication with the gNB (in uplink). For example, the UL codebook may comprise a first sub-codebook (e.g., sub-codebook1 corresponding to a first WTRU-panel) and a second sub-codebook (e.g., sub-codebook2 corresponding to a second WTRU-panel).

In an example, the WTRU may receive UL grant information (e.g., DCI) indicating at least two TPMI indexes where a first TPMI index of the at least two TPMI indexes may be indicated based on the first sub-codebook, and a second TPMI index of the at least two TPMI indexes may be indicated based on the second sub-codebook. In an example, the WTRU may receive information indicating at least one inter-panel-TPMI index (e.g., value) (e.g., in UL grant information), where the at least one inter-panel-TPMI index (e.g., value) may be applied between indicated two TPMIs (e.g., the first TPMI and the second TPMI). The accuracy in indicating a beam (e.g., precoder) for a PUSCH may be improved e.g., based on a combination among the first TPMI, the second TPMI, and the inter-panel-TPMI.

In a third example, the one or more capability parameters may indicate a level of regularity (e.g., uniformity) among UL antenna ports e.g., in terms of a (e.g., geographical) distance between (e.g., any) two UL antenna ports that may be supported (e.g., implemented) by the WTRU. For example, the level of regularity (e.g., uniformity) may be pre-defined based on a number L of level(s), where L may be any integer number between 0, and a maximum number of levels, which may be referred to herein as Lₘₐₓ.

In a case where, for example, the number of levels (e.g., being reported) is equal to the maximum number of levels (e.g., if L=Lₘₐₓ), any of a UL codebook and corresponding TPMI index(es) may be determined (e.g., constructed configured, indicated, used) for the WTRU, based on availability of an equal distance between two UL antenna ports, e.g., associated with a uniform (e.g., linear) array. For example, the gNB may transmit information indicating any of the determined UL codebook and corresponding TPMI index(es).

In a case where, for example, the number of levels (e.g., being reported) is equal to zero (e.g., if L=0), any of a UL codebook and corresponding TPMI index(es) may be determined (e.g., constructed, configured, indicated, used) for the WTRU, without availability of an equal distance between two UL antenna ports. For example, any of a UL codebook and corresponding TPMI index(es) may be determined in a random sampling manner for a (e.g., each) precoder (e.g., TPMI) generation. For example, the random sampling manner may be applied (e.g., performed) within a restricted beam (e.g., spatial) domain, e.g., based on a WTRU-panel coverage (if P>=2 is reported, etc.).

In a case where, for example, the number of levels (e.g., being reported) is comprised between zero and the maximum number of levels (e.g., if 0<L<Lₘₐₓ), any of a UL codebook and corresponding TPMI index(es) may be determined (e.g., constructed, configured, indicated, used) for the WTRU, based on any combination (or based on mixing subsets of TPMIs) between the case of L=Lₘₐₓ and the case of L=0.

For example, transmitting (e.g., reporting) one or more (e.g., capability) parameters indicating (e.g., representing, reflecting) the WTRU's antenna (e.g., panel) structure, as described herein may improve uplink performance by allowing the WTRU to apply a flexible (e.g., scalable) UL codebook determination (e.g., construction, generation).

### Example of Coherency-Based Precoding Codebook Determination

For example, a WTRU may transmit information indicating its coherence capability e.g., for selection of the precoder subset by the gNB. For example, the WTRU may transmit (e.g., report) information indicating more than one coherence capability. In an embodiment, a WTRU may transmit information indicating its coherence capability based on the configured codebook. For example, a WTRU may transmit (e.g., report) information indicating one type of coherence capability in a case where the WTRU is configured with Kronecker-based codebook, and another type of coherence capability in a case where the WTRU is configured with a codebook corresponding to an array of uniform linear array. In an embodiment, a WTRU may transmit information indicating its coherence capability per any of CW and panel. For example, a WTRU may transmit information indicating partial coherency for single CW transmission, and full coherency for two CW transmission. For example, a WTRU may transmit information indicating partial coherency for two panel transmission, and full coherency for per panel transmission.

In an embodiment, a WTRU may transmit information indicating one or more (e.g., capability) parameters indicating (e.g., representing, reflecting) a coherency capability across any of the antennas and the panels of the WTRU that may be used for any of determining one or more UL-codebooks of a plurality of UL-codebooks and for selection of the precoder subset by the gNB. For example, the plurality of UL-codebooks may be any of pre-defined, pre-determined, pre-configured in the WTRU, and indicated by configuration information that may be received by the WTRU.

For example, the WTRU may transmit information indicating more than one coherence capability e.g., for a codebook based WTRU transmission scheme.

In an embodiment, a WTRU may transmit information indicating its coherence capability based on the configured UL codebook. For example, a WTRU may transmit information indicating one type of coherence capability in a case where the WTRU is configured with a first (e.g., Kronecker-based) codebook, and another type of coherence capability in a case where the WTRU configured with a second codebook (e.g., corresponding to an array type of antenna structure such as e.g., a uniform linear array, etc.).

In an embodiment, a WTRU may transmit information indicating its coherence capability any of per CW and per WTRU-panel.

In a first example, a WTRU may transmit information indicating a ‘partial coherency’ for a single CW transmission (e.g., case), and a ‘full coherency’ for two CW transmission (e.g., case):

The WTRU may receive, for example, (e.g., configuration) information indicating whether a single CW may be used or a two CWs may be used for subsequent UL transmissions. For example, in response to receiving the (e.g., configuration) information, a UL codebook to be applied for subsequent UL transmissions may be selected (e.g., changed, updated).

In a case where, for example, a single CW transmission mode is indicated (e.g., by received information), the WTRU may determine a first UL codebook (e.g., being constructed) based on the partial coherency (e.g., where one or more TPMIs of the first UL codebook may be generated based on an availability of the partial coherency).

In a case where, for example, the two CW transmission mode is indicated (e.g., by received information), the WTRU may determine a second UL codebook (e.g., being constructed) based on the full coherency (e.g., where one or more TPMIs of the second UL codebook may be generated based on an availability of the full coherency).

In a second example, a WTRU may transmit information indicating a ‘partial coherency’ for (simultaneous) multi-panel (SMP) transmission operation, and a ‘full coherency’ for a per-panel UL transmission operation:

The WTRU may receive, for example, (e.g., configuration) information indicating whether a SMP transmission mode or a non-SMP transmission mode may be used (e.g., applied) for subsequent UL transmissions. In response to receiving the (e.g., configuration) information, a UL codebook to be applied for subsequent UL transmissions may be selected (e.g., changed).

In a case where, for example, the SMP transmission mode is any of indicated (e.g., by received information) and enabled, the WTRU may determine a first UL codebook (e.g., being constructed) based on the partial coherency (e.g., where one or more TPMIs of the first UL codebook may be generated based on an availability of the partial coherency).

In a case where, for example, the non-SMP (e.g., per-panel UL) transmission mode is any of indicated (e.g., by received information) and enabled, the WTRU may determine a second UL codebook (e.g., being constructed) based on the full coherency (e.g., where one or more TPMIs of the second UL codebook may be generated based on an availability of the full coherency).

For example, transmitting information indicating one or more (e.g., capability) parameters indicating (e.g., representing, reflecting) a coherency capability across any of antennas and the panels of the WTRU may improve uplink performance by allowing the WTRU to apply a flexible (e.g., scalable) UL codebook determination, (e.g., construction, generation).

### Example of Virtualization-Based Precoding Codebook Determination

For example, a WTRU may transmit information indicating its virtualization capability as how the combining over different or same polarization may be performed. For example, in a case where a WTRU is configured to apply a Kronecker-based precoder, the WTRU may receive information indicating a configuration for 8 port SRS along with definition of virtualization. For example, the SRS configuration may be enhanced (e.g., extended) to include virtualization information. In another example, a WTRU may receive information indicating a configuration for 8 port SRS, and the virtualization may be based on (e.g., determined by) the WTRU implementation. For example, the WTRU may transmit information indicating its virtualization capability.

For example, a WTRU may include one or more polarized antenna elements that may be arranged into one or more antenna panels. For example, a (e.g., each) antenna panel may be (e.g., defined as) a rectangular array of M rows and N columns of antenna elements. The total number of antenna elements may be counted as M*N*P where P may be the number of polarizations (e.g., 2 if dual polarized).

For example, a WTRU may apply a linear combination vector across a set of antenna elements along any of the vertical and the horizontal dimension such that the set of antenna elements may be mapped to (e.g., associated with) a single antenna port. This mapping (e.g., association) operation may be referred to herein as port virtualization. For example, the linear combination may include an angular component such that the antenna port may be transmitted with an effective fixed tilting angle. For example, for a general array the antenna port array may be referred to herein as VxHy, where x may be the number of vertical antenna ports, and y may be the number of horizontal antenna ports for a total number of x*y antenna ports. For example, an array of four vertical antenna elements may be virtualized into one antenna port with a down tilt of 100 degrees. This configuration may be referred to herein as (M,N,P)=(4,1,1) that may be virtualized into V1H1 antenna port. The same array may be virtualized into different combinations of V and H. For example, for the same array, a WTRU may virtualize the antenna elements pairwise into a V2H1 configuration where a (e.g., each) antenna port may be a linear combination of two antenna elements. For example, a WTRU may obtain (e.g., a maximum of) V*H=M*N*P antenna ports in a case where one antenna element is virtualized per antenna port.

For example, a WTRU may apply a precoder across the antenna port where the precoder may be (e.g., defined as) a linear combination of the signals from different antenna ports. The precoder may be represented by a vector of complex numbers, and the number of rows of the vectors may be equal to the number of transmit antenna ports. In a case where more than one layer is supported, the precoder may be (e.g., represented by) a matrix where the number of columns may be equal to the number of layers.

In Rel-17 NR, the network may pre-code a downlink transmission for a two-dimensional array of antenna ports. For such two-dimensional antenna arrays, a Kronecker-based precoding codebook may be defined as a function of the number of vertical and horizontal antenna ports x and y. For example, the codebook may include one or more precoders with one index per codebook identifying one (e.g., precoder) entry in the codebook. For example, a first linear combination vector may be used across horizontal antenna ports, and a second linear combination vector may be used across vertical antenna ports. The precoder may be determined (e.g., constructed) from the Kronecker product of horizontal and vertical linear combination vectors, and the precoder may be identified by one index. In another example, one precoder may be identified by more than one index, where a (e.g., each) index may identify one horizontal and one vertical linear combination vectors, respectively.

For example, different numbers of vertical and horizontal antenna ports may produce different angular resolutions in any of the vertical and the horizontal domains. In the downlink, the VxHy parameters may be indicated to the WTRU through information indicating a CSI reporting configuration. For example, the parameters may remain static (e.g., due to a fixed transmitter).

Reporting a capability for supporting different antenna virtualizations by a WTRU is described herein.

In Rel-17 NR, the Kronecker codebook may not be used on the uplink. For example, depending on any of the WTRU location and direction of movement with respect to the network, the WTRU may determine different (e.g., optimal) VxHy antenna port combinations which may depend on any of the WTRU panel, and the receiving TRP. For example, a WTRU may determine a precoder for the uplink as a function of the downlink Kronecker-based codebook.

In an embodiment, a WTRU may transmit capability information indicating a capability for virtualization to the network. The capability information may indicate one or more of the following:

In a first example, the capability information may indicate the dimensions of its antenna array such as any of the number of vertical antenna elements, the number of horizontal network elements and the number of polarizations (e.g., M, N, and P).

In a second example, the capability information may indicate one or more virtualization configurations (e.g., VxHy).

In a third example, the capability information may indicate the number of ports supported (e.g., up to eight)

In a fourth example, the capability information may indicate a dynamic virtualization switching capability (e.g., indicating whether VxHy may be switched dynamically or not). For example, the capability information may include a flag indicating if two antenna port configurations may be switched within a delay satisfying a condition (e.g., less than a threshold T). For example, the WTRU may receive information indicating the condition (e.g., the threshold T) from the network as part of the (e.g., information indicating) a CSI reporting configuration.

In a fifth example, the capability information may indicate a panel index per any of antenna array and VxHy configuration.

In a sixth example, the capability information may indicate a support for Kronecker-based codebook.

For example, after sending information indicating its capability to support Kronecker-based codebook, a WTRU may (e.g., expect to) be scheduled with any of Kronecker, and non-Kronecker based codebook. For example, a WTRU may receive information indicating a CSI reporting configuration for the uplink transmission with a flag, and the WTRU may determine to use a Kronecker-based codebook for the uplink transmission as a function of the flag. For example, in a case where the flag indicates off, the WTRU may use a non-Kronecker based codebook. For example, in a case where the flag indicates on, the WTRU may use a Kronecker based codebook. In another example, the WTRU may receive information indicating the flag dynamically as part of the grant information (e.g., DCI).

For example, the network may generate a codepoint table based on the capability information, where a (e.g., each) codepoint may be associated with one VxHy configuration. For example, a WTRU may receive information indicating the codepoint table. For example, the WTRU may switch the VxHy configuration for uplink transmission as a function of receiving information indicating one index from the codepoint table e.g., through a grant information (e.g., DCI). For example, the WTRU may transmit first information indicating a capability for V1H2 and V2H1. The WTRU may receive second information indicating a codepoint table where index 0 may indicate V1H2, and index 1 may indicate V2H1. For example, the WTRU may receive grant information indicating a grant for PUSCH with an index 0 from the codepoint, and the WTRU may determine the codebook for the precoder (e.g., a Kronecker-based codebook for V2H1 ports) as a function of the codepoint. For example, the WTRU may determine the TPMI indicating a precoder from the V2H1 codebook.

For example, a WTRU may determine a VxHy configuration based on receiving information indicating an UL transmit configuration indication (TCI). For example, A WTRU may receive UL TCI information which may include (e.g., indicate) any of a quasi-colocation (QCL) relationship to a reference signal (RS) with a determined VxHy, and an explicit indication of the VxHy to use with the UL TCI. For example, an UL TCI may be configured to be QCL'd with an SRS using V2H1. VxHy may correspond to a new QCL type for the UL TCI (e.g., type-VH), where a target RS may be (e.g., considered as) QCL'd type-VH with a source RS on a condition that the antenna ports of the target RS are virtualized with the same VxHy configuration as the source RS.

In an embodiment, a WTRU may determine the (e.g., choice of) VxHy configuration as a function of any of a WTRU measurement and a condition. For example, the WTRU may determine the (e.g., preferred) VxHy configuration based on measurements made over one or more DL RS, where the WTRU may change its VxHy configuration at different time instances. For example, considering reciprocity, the same configuration used for receiving a DL RS may be used for SRS transmission.

For example, a WTRU may receive one channel state information reference signal (CSI-RS) with receive antenna ports virtualized as V1H1, and the same CSI-RS at a separate time instance with V2H1. For example, the WTRU may measure the received signal quality for (e.g., each of) the two CSI-RS. For example, the WTRU may determine that the received signal quality on V2H1 may be higher than for V1H1. For example, the WTRU may transmit information indicating a CSI report that may include the VxHy configuration used for the (e.g., each) CSI resource indicator (CRI) together with the associated signal quality (e.g., any of a reference signal received power (RSRP), a signal to noise ratio (SNR), a signal to interference and noise ratio (SINR)).

In another example, a (e.g., each) CRI may be associated with a WTRU VxHy configuration such that a WTRU may implicitly indicate the VxHy configuration through (e.g., transmitting information indicating) a CRI. For example, a WTRU may receive configuration information indicating a CSI-RS configuration where a (e.g., each) CRI may include (e.g., be associated with) a VxHy configuration for the WTRU to use when receiving.

In another example, a WTRU may cycle through different VxHy configurations. For example, a WTRU may receive a CSI-RS with two repetitions (e.g., two transmissions), and a WTRU may use one VxHy configuration for reception of the first repetition (e.g., first transmission), and a second configuration for the second repetition (e.g., second transmission). For example, the WTRU may cycle through a pattern of VxHy that may be preconfigured (e.g., cyclical or sequential) in a case where more than one virtualization is supported (e.g., available).

In an embodiment, a WTRU may receive information indicating an SRS configuration with more than one VxHy configuration. For example, the WTRU may select one configuration for SRS transmission any of semi-statically and dynamically.

For example, for an aperiodic SRS (A-SRS), a WTRU may receive information indicating a triggering command which may include an indication of the VxHy configuration to use.

In another example, one VxHy configuration may be activated per SRS resource set such that a WTRU may determine to use it for any SRS resource included in the resource set. The WTRU may receive information (e.g., such as a MAC control element (MAC-CE)) indicating to activate one configuration. In another example, the WTRU may transmit information such as e.g., a MAC-CE indicating to activate one VxHy configuration.

In another example, more than one VxHy configuration may be included in one SRS resource set, and a WTRU may determine a VxHy configuration as a function of the SRS resource index.

In another example, the WTRU may transmit one SRS configuration with dynamically switching VxHy configuration. For example, a first repetition (e.g., transmission) may map to (e.g., be associated with) a first VxHy configuration (e.g., VIH2) and a second repetition (e.g., transmission) may map to (e.g., be associated with) a second VxHy configuration (V2H1).

For example, a (e.g., each) configuration may be associated with a number of SRS antenna ports. For example, any SRS resource with 8 antenna ports may use one VxHy configuration, whereas other numbers (e.g., sizes) of antenna ports configuration may use another VxHy configuration.

For example, a WTRU may determine a VxHy configuration and may transmit information indicating the determined VxHy configuration to the network. For example, the WTRU may (e.g., expect to) receive grant information indicating an uplink grant and a TPMI from a codebook with the determined VxHy configuration. For example, the WTRU may receive (e.g., semi-statically) configuration information indicating a codebook configuration (e.g., any of Kronecker and non-Kronecker) for codebook selection and TPMI indications. For example, the WTRU may determine a precoding codebook as a function of any of the number of antenna ports, a VxHy configuration, and an SRI. For example, a Kronecker-based codebook may be used (e.g., only) for 8 antenna ports precoders and other antenna ports may use other codebooks (e.g., as defined in NR Rel-17). For example, in a case where the WTRU receives grant information indicating an uplink grant for 8 antenna port for a PUSCH transmission, the WTRU may determine to use a precoder from the 8-antenna port Kronecker-based codebook, and the WTRU may determine the parameters of the codebook (e.g., VxHy) based on the SRI indicated in the grant information in a case where the (e.g., each) SRI is associated with a VxHy. For example, in a case where the SRI (e.g., only) indicates the number of ports, the WTRU may receive additional information indicating the VxHy parameters such that the WTRU may index (e.g., determine, select) the TPMI from the correct codebook. For example, in a case where the WTRU receives grant information indicating an uplink grant with a 4 port SRI, the WTRU may receive additional flag information indicating whether to use Kronecker or non-Kronecker based codebook.

### Example of Dynamic Activation of a Precoding Codebook

In an embodiment, a WTRU may support (e.g., use, operate) one or more codebooks for uplink precoding based on a set of WTRU reported capabilities, for example, any of a RF/antenna/panel structure, a coherence capability, a virtualization capability, etc. In an embodiment, the WTRU may use one or more of the following three examples to determine the codebook for uplink precoding:

In a first example, (e.g., in addition to transmitting information indicating the (e.g., supported) capabilities), the WTRU may transmit information indicating supporting codebooks for a (e.g., each supported) capability.

In a second example, the WTRU may (e.g., only) transmit information indicating its (e.g., implementation-based) capabilities, such as e.g., any of antenna structure, coherency, virtualization, etc., from which the supporting codebook may be implicitly determined.

In a third example, the WTRU may (e.g., only) transmit information indicating its supported codebooks for uplink transmission. For example, the WTRU may not transmit information indicating its (e.g., implementation-based) capabilities, such as e.g., any of antenna structure, coherency, virtualization.

In an embodiment, a (e.g., each) codebook may be used for a subset of the indicated (e.g., reported) capabilities. For example, a WTRU may be able to support a fully coherent codebook for a first subset of panels (e.g., one panel), and a partially coherent codebook for transmission from a second subset of panels (e.g., two panels). In another example, a WTRU may support a first number of SRS ports on one panel (e.g., associated with a first codebook), and a second number of SRS ports for another panel (e.g., associated with a second codebook).

In an embodiment, based on the transmitted (e.g., reported) capability information, a WTRU may receive any of semi-static information and dynamic information indicating to use a (e.g., specific) codebook for interpreting the received TPMI.

In a first example, a WTRU may receive (e.g., semi-static) information indicating an radio resource control (RRC) configuration (e.g., via RRC signaling). For example, the RRC configuration may indicate one of the supported codebooks to be used (e.g., semi-statically).

In a second example, a WTRU may receive (e.g., dynamic) information indicating to activate a codebook for interpretation of a TPMI. For example, the WTRU may receive any of a MAC CE and a DCI to activate one or more of codebooks for usage of the WTRU. For example, the WTRU may receive (e.g., additional) information such as e.g., a DCI field in the scheduling DCI indicating a selection (e.g., activation) of a (e.g., specific) codebook. For example, the activated codebook based on the received information may remain valid till the reception of another dynamic information indicating any of to deactivate the selected codebook and to select a different codebook. In another example, the activated codebook may expire after a validity period. For example, the validity period may be any of fixed (e.g., pre-configured) and configured based on any of received configuration information, WTRU capability, WTRU mobility, etc. For example, after the codebook may have expired, a default codebook may be used.

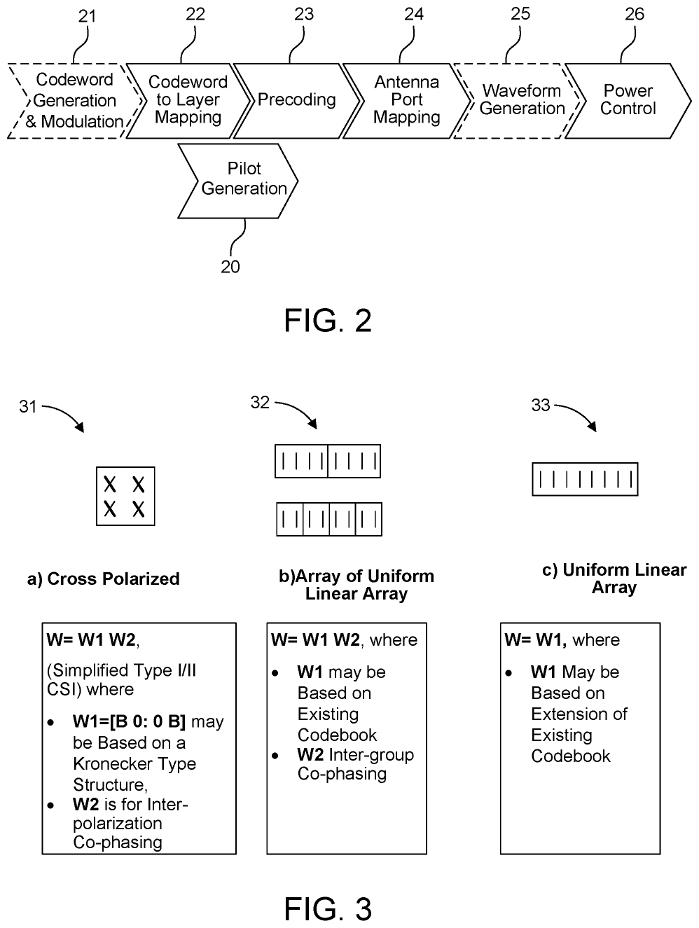

FIG. 5 is a diagram illustrating an example of a method for UL codebook and precoding determination based on WTRU antenna layout.

As shown at 51, a WTRU may transmit capability information comprising, for example, antenna layout information. For example, the capability information may indicate the capability of the WTRU for supporting at least one codebook for (e.g., any of uplink and sidelink) transmissions. The capability information may be indicated in an implicit and/or an explicit manner.

For example, the capability information may indicate a number of antenna groups (which may be referred to herein as Ng). For example, a (e.g., each, one or more) antenna group may be associated with a coherence capability. For example, the capability information may indicate for a (e.g., each) antenna group a coherence capability associated with the antenna group.

In an example, a WTRU may explicitly indicate which types of codebooks may be supported. For example, the (e.g., capability information transmitted by the) WTRU may indicate whether a codebook based on NR Rel-15 DL codebook, and/or based on NR Rel-15 UL codebook, and/or a subset thereof, etc. may be supported. For example, a WTRU may indicate explicitly (e.g., in the capability information) the number of the antenna groups, Ng.

In another example, a WTRU may implicitly indicate the codebook(s) and/or the number of antenna groups. In an example, a WTRU may indicate the number of antenna groups Ng as an implicit indication of the type of the codebook (e.g., a capability information indicating a number of antenna groups may (e.g., implicitly) indicate a type of codebook). In another example, the indication of the codebook and/or number of antenna group may be based on the coherency capability indication (e.g., information). For example, a WTRU may indicate to use a first category (e.g., type) of codebook by indicating its full coherency capability and may indicate to use a second category (e.g., type) of codebook by indicating its partially coherent or non-coherent capability. For example, a first category (e.g., type) of codebook may be associated with a full coherency capability, and a second category (e.g., type) of codebook may be associated with partially coherent and/or non-coherent capability. For example, the capability information (e.g., transmitted by the WTRU) may include additional information regarding (e.g., indicating) supporting parameters of the WTRU for the (e.g., implicitly) indicated category. Additional information may include information related to parametrization of codebook, such as e.g., any of oversampling ratios, number of horizontal and vertical beams, etc.

As shown at 52, the WTRU may receive configuration information indicating one codebook or more than one codebook (e.g., based on the transmitted capability information).

As shown at 53, the WTRU may receive scheduling information for a (e.g., any of uplink and sidelink) transmission, such as e.g., a PUSCH scheduling. For example, depending on the type of the codebook and the number of antenna groups, the scheduling information may indicate any of (i) a codebook indicator and one TPMI, and (ii) a plurality of TPMIs where, for example, each TPMI may be associated with an antenna group.

In a first example, the scheduling information may indicate a codebook indicator and one TPMI, e.g., in a case where the number of antenna groups is one.

In a second example, the scheduling information may indicate a plurality of TPMIs. For example, a (e.g., each) TPMI may be associated with an antenna group. For example, the scheduling information may indicate a plurality of TPMIs in a case where the number of antenna groups is (e.g., strictly) greater than one.

As shown at 54, the WTRU may execute (e.g., perform) the transmission based on a codebook of the one codebook or the more than one codebook and (a) the one TPMI or (b) the plurality of TPMIs that may have been indicated by the scheduling information. The codebook for performing the transmission may be the codebook indicated by any of the configuration information and the codebook indicator.

In various embodiments, the configuration information may indicate more than one codebook. For example, the codebook indicator (e.g., indicated by the scheduling information) may indicate the codebook of the indicated more than one codebook, e.g., to be used for the scheduled transmission.

In various embodiments, in a case where the number of antenna groups is one, the codebook of the one codebook or the more than one codebook (e.g., used for performing the transmission) may have been indicated in the configuration information.

In various embodiments, the configuration information may indicate a single (e.g., configured) codebook. For example, the transmission may be performed based on the single (e.g., configured) codebook and the plurality of TPMIs (e.g., the plurality of TPMIs being associated with the single configured codebook).

### Example of CSI Indication and Overhead Management

For example, WTRUs with many antennas may be used for any of fixed wireless access and customer premises equipment. Given the relative static nature of the wireless channel, in e.g., fixed wireless access, supporting indication of CSI and some other scheduling information through a dynamic indication may be avoided. For example, CSI and other scheduling information may be spread over any of RRC, MAC CE and DCI (e.g., information) indication. At a high level, information that may be indicated (e.g., transmitted) to the WTRU may be split to two groups of slow- and fast-changing components.

In an embodiment, a WTRU may receive a first set of (e.g., CSI and scheduling) information through any of RRC and MAC CE configuration, and a second set of information through a dynamic (e.g., information) indication (e.g., transmission).

For example, a WTRU may determine any of a rank information, an MCS information and an antenna port indication based on the first set of information received through any of RRC and MAC CE signaling, and the WTRU may determine other information such as any of a TPMI, a time domain resource allocation (TDRA), etc., from the second set of (e.g., scheduling DCI) information. Separating indication transmissions of rank and precoding information may allow to reduce the overhead for TPMI indication where e.g., precoding and rank information may be indicated by the same received TPMI.

In NR Rel-17, the uplink precoding may be based on a single stage precoding with limited resolution. Supporting higher-resolution codebooks may increase the CSI payload that may be carried in a DCI.

In a first example, a WTRU may receive first information indicating slower-changing components of CSI (e.g., coarse resolution), such as e.g., wideband precoder, beam information, etc., by a first indication (e.g., first transmission), and second information indicating faster-changing elements of CSI (e.g., fine resolution), such as e.g., sub-band coefficients by a second indication (e.g., second transmission). Separating slower changing component indication and faster changing component indication in two different information transmissions may allow to support CSI for a higher-resolution codebook, e.g., Type II CSI, and to keep the resulting overhead limited. For example, the first information may be based on (e.g., transmitted via) any of RRC and MAC CE signaling, and the second information may be received by using any of MAC CE and DCI indication.

In a second example, the WTRU may not receive information indicating an estimated CSI. For example, the WTRU may receive information indicating a change from a last reported (e.g., transmitted) value, such as e.g., a differential indication of CSI. Differential indication may allow to leverage the relative static nature of the channel, such that the impact of PDCCH miss and error propagation may remain limited. For example, a WTRU may use (e.g., receive information indicating) differential indication for a subset of the CSI elements. For example, a WTRU may receive information indicating a set of incremental correction in beam combining coefficients, (e.g., and not the actual (e.g., full) values).

In a third example, a WTRU may determine the CSI information by receiving two DCIs. For example, the WTRU may receive a first and a second DCI where the WTRU may receive the first DCI at a higher frequency (e.g., more often) than a second DCI. For example, the first DCI may include faster-changing scheduling information indicating e.g., any of TDRA, W2, etc., and the second DCI may include slower-changing information related to the slower-changing CSI, indicating e.g., any of rank, Wi, etc. In another example, the WTRU may receive a first DCI scheduling a first uplink transmission with a fixed length, and a second DCI scheduling a second uplink transmission with a variable length that may be indicated by the first DCI. For example, the WTRU may receive a second DCI (e.g., only) in a case where channel-related information is updated.

In an embodiment, the set of Tx antennas of a WTRU may be grouped in one or more subsets. The grouping of the Tx antennas may be fixed, for example, based on WTRU implementation. For example, a WTRU may transmit, to the gNB, (e.g., capability) information indicating the grouping of the Tx antennas in different subsets. The (e.g., capability) information may indicate any of the number of subsets, the number of Tx antennas per subset, a coherence capability, a power capability, a virtualization capability, etc. For example, the WTRU may receive (e.g., any of semi-static and dynamic) configuration information for an uplink transmission according to the (e.g., capability) information transmitted to the gNB.

In an embodiment, a WTRU may use more than one of the antenna subsets for an uplink transmission. For example, a WTRU may receive information indicating one or more (e.g., sets of) transmission configuration parameters, such as e.g., any of transmission rank(s), precoding, and beam indication corresponding to a (e.g., each) subset.

In a first example, a WTRU may receive (e.g., be indicated with) more than one set of uplink transmission information where a (e.g., each) set of uplink transmission information may be applied to at least one subset. For example, a WTRU with 8Tx antennas that may be partitioned to two subsets of 4Tx antennas, may receive separate uplink transmission configuration (e.g., information) for each subset, e.g., corresponding to 4Tx uplink transmission operation. The received (e.g., uplink transmission) configuration information per subset may include any of a TPMI, a SRI, etc., that may determine the overall transmission using 8Tx. For example, a WTRU may use a 4Tx codebook, e.g., the legacy NR Rel-17 UL 4Tx codebook for determination of the uplink precoder for (e.g., each of) the subsets. For example, a WTRU may receive two sets of uplink transmission information (such as e.g., any of TPMI, and SRI), in a scheduling DCI (e.g., uplink grant information).

A second (e.g., set of) uplink transmission information may be, for example, conditioned on a first (e.g., set of) uplink transmission information. For example, a first TPMI may indicate an index from the full codebook of N_TPMIs (where N_TPMIs may be referred to as the number of TPMIs), and a second TPMI may indicate an index from a subset of the N_TPMIs. Conditioning a second (e.g., set of) uplink transmission information on a first (e.g., set of) uplink transmission information may allow to reduce the payload of the second TPMI to fewer bits than the first TPMI by constraining the second TPMI selection from fewer precoders. For example, the WTRU may determine the subset by receiving (e.g., RRC) configuration information, or by receiving information indicating a codebook subset restriction (e.g., dynamically) in a DCI. For example, the subset may be restricted to a single (e.g., second) TPMI (e.g., index) that may be associated with a first TPMI (e.g., index).

In a second example, a WTRU may receive information indicating (e.g., be indicated with) only one set of transmission configuration parameters per transmission, where the transmission configuration parameters may include any of rank, precoding, and SRI indication. For example, a WTRU with 8Tx antennas that may be partitioned to two subsets of 4Tx antennas, may receive information indicating a single transmission configuration to be applied (e.g., only) to one subset of Tx antennas.

For example, a WTRU may receive a dynamic indication (e.g., information) by any of a MAC CE and a DCI to determine (e.g., indicating) the Tx antenna subset that the precoding information may be intended for (e.g., associated with).

For example, a WTRU may alternate application of the received indication (e.g., information indicating a single set of transmission configuration parameters) based on a time reference, for example, based on one or more of: (i) a slot number (e.g., any of odd, even, etc.), (ii) a configurable counter, (iii) a timer and/or a time-based pattern. The configurable counter may be configured based on, for example, any of channel condition, bandwidth part, etc. The timer, for example, may indicate that (e.g., all) dynamic indications for the next T seconds may apply to a subset index. The time-based pattern, for example, may cycle through (e.g., all) subsets (e.g., the WTRU may determine that a first dynamic indication may apply to a first subset i, then the next (e.g., a second) dynamic indication to a second subset i+1, etc.).

For example, a WTRU may alternate application of the received indication (e.g., information indicating a single set of transmission configuration parameters) based on any of a transmission parameter and a change in transmission parameter, such as e.g., any of a scheduled bandwidth, a demodulation reference signal (DMRS) configuration, a bandwidth part, etc.

In a third example, a WTRU may receive information indicating (e.g., be indicated with) only one set of transmission configuration parameters (e.g., any of rank, precoding, and SRI indication) per transmission, where any of a same precoder and beam indication may be simultaneously used for (e.g., all) Tx subsets. For example, a WTRU with 8Tx antennas that may be partitioned to two subsets of 4Tx antennas, may receive information indicating a single transmission configuration to be simultaneously applied to the two subsets of Tx antennas, e.g., same rank, precoder and beam.

In a fourth example, a WTRU may receive information indicating (e.g., be indicated with) only one (e.g., first) set of transmission configuration parameters (e.g., any of rank, precoding, and SRI indication) which may apply to (e.g., may be associated with) a first Tx subset, and the WTRU may determine a second set of transmission configuration parameters (e.g., any of rank, precoding, and SRI indication) for a second Tx subset as a function of the first indication (e.g., of the first set of transmission configuration parameters) for the first Tx subset.

For example, the WTRU may determine the second TPMI based on any of a preconfigured and WTRU determined association between a (e.g., each) TPMI index in the codebook and a second TPMI index. For example, the WTRU may receive (e.g., first precoding) information indicating a first TPMI (which may be referred to as TPMI1) for (e.g., associated with) the first 4Tx antennas. For example, the first TPMI may be linked to (e.g., associated with) a second TPMI (which may be referred to as TPMI2). The association between the first TPMI and the second TPMI may be any of pre-configured and received (e.g., from the gNB) in association information. For example, the WTRU may determine to apply the second TPMI to the second subset of 4Tx antennas in a case where it receives information indicating the first TPMI for the first subset. The link (e.g., association) between TPMIs may be based on WTRU reported channel quality . . . ). For example, a first TPMI may be linked (e.g., associated with) a second TPMI on condition that a first quality metric associated with (e.g., a previous transmission of the WTRU based on) the first TPMI and a second quality metric associated with (e.g., a previous transmission of the WTRU based on) the second TPMI satisfy a quality condition (e.g., TPMI1 and TPMI2 may be PMIs reported with the highest and second highest channel quality indicator (CQI), respectively, or SRI1 and SRI2 may be the SRIs with the highest and second highest RSRP, etc. For example, association information indicating that the second TPMI may be associated with the first TPMI may be transmitted to the WTRU by the gNB in any configuration information. In embodiments described herein the terms “first TPMI”, “TPMI1”, “first TPMI index” may be used interchangeably to refer to a first TPMI of a plurality of TPMIs in a codebook. In embodiments described herein the terms “second TPMI”, “TPMI2”, “second TPMI index” may be used interchangeably to refer to a second TPMI of the plurality of TPMIs in the codebook.

For example, a first antenna subset may correspond to a first antenna polarization, and a second antenna subset may correspond to a second antenna polarization. A WTRU may receive information indicating a first TPMI. The WTRU may determine that the first TPMI may apply to the first subset, and that the first TPMI multiplied by a co-phasing factor may apply to the second subset. For example, the WTRU may determine the value of the co-phasing factor. In another example, the WTRU may receive information indicating the co-phasing factor (e.g., together) with the first TPMI in any of a DCI and a MAC-CE. For example, the WTRU may determine the co-phasing factor from a codebook of scaling factors (e.g., QPSK discrete set). For example, the co-phasing factor may be determined by the WTRU based on any of its capability and antenna configuration.

In NR Rel-17, a TPMI may be used as an indication of the uplink transmission rank and uplink precoding. Embodiments described herein may allow to reduce the CSI payload. For example, a WTRU may receive first configuration information indicating uplink transmission rank information. The first configuration information may indicate any of a maximum transmission rank, and one or more (e.g., specific) transmission ranks. For example, the WTRU may receive second information indicating a precoding or a beam (e.g., indication) corresponding to (e.g., associated with) the indicated uplink transmission rank information. For example, the first configuration information and the second information may be received in separate transmissions.

In an embodiment, a received uplink transmission rank information may be valid till second configuration information indicating another uplink transmission rank information may be received, or for a (e.g., bounded) duration in time that may be determined by any of a counter and another transmission event, such as e.g., radio link failure (RLF), etc.

In an embodiment, a WTRU may receive first (e.g., any of semi-static and dynamic) configuration information (e.g., via any of RRC, MAC CE, DCI, etc.) indicating a (e.g., specific) transmission rank. For example, the WTRU may receive second (e.g., dynamic) configuration information indicating a precoding or beam (e.g., indication) e.g., by any of a MAC CE and DCI, where the indicated precoder or beam may correspond to (e.g., be associated with) the configured (e.g., indicated) transmission rank.

For example, a WTRU may be any of pre-configured and semi-statically configured by receiving information indicating a (e.g., specific) number of any of available precoding and beam options for a (e.g., each) rank. For example, a WTRU may have a first number (which may be referred to herein as N1) of precoding or beam options for a first rank (which may be referred to herein as Rank1), a second number (which may be referred to herein as N2) of precoding or beam options for a second rank (which may be referred to herein as Rank2) etc., such that the CSI payload growth may remain limited as the number of antennas of a WTRU may increase. For example, for a (e.g., given) codepoint indicated in a received DCI, a WTRU may apply a different beam or precoding according to the configured rank. For example, a WTRU may have a same number (N1=N2= . . . =N)_ of Tx precoding and/or beam options for (e.g., all) transmission ranks.

For example, an 8Tx WTRU may receive configuration information indicating to operate with (e.g., only) two and four layers. In a case where, for the configured layers, N2 and N4 precoding options are supported, the length of the DCI codepoint for indicating precoding information may be lower than log₂(N2+N4), e.g., as other rank options are not supported. Similarly, for beam or SRI indication, the DCI size may be lower than

$$log 2 ( ( \begin{matrix}8 \\ 2\end{matrix} ) + ( \begin{matrix}8 \\ 4\end{matrix} ) ) .$$

### Example of Support of Full-Power Modes

In NR Rel-16, two modes of full power operation may allow to support full power transmission for partially coherent and non-coherent WTRUs. In a first mode (which may be referred to herein as Mode 1), the gNB may transmit information indicating (e.g., only) TPMIs that may have (e.g., all) non-zero elements. In a second mode (which may be referred to herein as Mode 2), according to the WTRU structure, the WTRU may transmit information indicating the subset of precoders that may be used by the gNB to support full power operation.

For example, in WTRUs with multiple (e.g., a large number of) antennas, RF and antenna structure may be more complex and architecturally may be different from one to another.

In a first example, to support full power uplink transmission, a WTRU may transmit additional (e.g., capability) information indicating e.g., any of a capability to support a plurality of antenna configurations, a virtualization capability (e.g., for supporting a plurality of antenna configurations), a RF architecture, a power rating capability, etc. For example, the WTRU may report (e.g., transmit) the information (e.g., indication) per any of panel, polarization, TRP, codebook, CW, etc.

In a second example, based on its reported (e.g., indicated) capability, a WTRU may receive information indicating to support a non-equal power assignment per any of CW, panel, TRP, etc.

In an embodiment, a WTRU may use a dual stage precoding, e.g., W=W1W2, where W1 and W2 may respectively represent wideband (e.g., long term) and sub-band (e.g., short term) precoding. For example, a WTRU may support full power transmission in Mode 2 and may transmit information indicating more than one set of precoder groups to indicate its full power capability.

In a first example, the WTRU may transmit information indicating a first and a second subsets of precoder where the first subset may be taken (e.g., selected) from the codebook for Wi precoders, and the second subset may be taken (e.g., selected) from the W2 precoders. For example, the WTRU may transmit information indicating one or more associations between member(s) of the first subset of precoders and member(s) of the second subset of precoders.

In second example, the WTRU may transmit information indicating a single group of precoders (G), wherein, a (e.g., each) member of a group G may represent a joint selection (e.g., each) taken from W1 and W2. For example, a member of the indicated group G(1) may represent the joint (e.g., association) of W1(2)W2(1) which may indicate that the joint selection of W1(2) and W2(1) may be used as one of the precoder options to deliver full power.

In an embodiment, a WTRU with 8Tx antennas may be configured to operate with a smaller number of Tx antennas. For example, the WTRU may receive any of semi-static and dynamic configuration information indicating to operate with an indicated number of Tx antennas.

In a first example, the WTRU may receive information indicating to change its Tx configuration according to its reported capability. For example, the WTRU may transmit information indicating its max deliverable power for a (e.g., each) Tx configuration.

In a second example, a WTRU may dynamically switch between 4Tx and 8Tx antenna according to its reported capability. For example, the WTRU may use different Tx configuration for transmission of different channels according to their expected reliability. In another example, the WTRU may transmit information indicating a request for a specific Tx configuration to achieve (e.g., obtain) an operational objective (e.g., to satisfy a condition) such as e.g., any of higher reliability, lower power consumption, etc. For example, the WTRU may receive information indicating to use a first transmit antenna configuration (e.g., 4Tx) for a first type of transmissions (e.g., PUSCH transmission without UCI), and to use a second transmit antenna configuration (e.g., 8Tx) for a second type of transmissions (e.g., any of a PUCCH transmission, an SRS transmission, and a PUSCH transmission with UCI). For example, the information indicating a Tx re-configuration may be received as part of a scheduling DCI. For example, the information indicating the re-configuration of Tx may be explicitly included in a DCI field (e.g., scheduling information for a transmission may indicate to use a transmit antenna configuration for the transmission). In another example, an indication for reconfiguration of Tx may be implicitly determined from the antenna port indication field in the received DCI (e.g., the scheduling information may indicate one or more antenna ports, and the WTRU may determine to use the transmit antenna configuration associated with the indicated one or more antenna ports).

For example, in a case where the WTRU is indicated to change its Tx configuration, e.g., from a first Tx configuration to a second Tx, a power imbalance may be experienced.

For example, to address the power imbalance, in a case where the WTRU switches from a first to a second Tx configuration, the WTRU may dynamically change its antenna port virtualization to deliver the expected power.

For example, in a case where information indicating a dynamic antenna port virtualization capability of the WTRU has been reported (e.g., transmitted by the WTRU), the WTRU may receive any of a semi-static and dynamic information, e.g., as part of the scheduling DCI, indicating to use its virtualization capability.

In another example, in a case where information indicating a dynamic antenna port virtualization capability of the WTRU has not been reported (e.g., transmitted), the WTRU may apply the virtualization, and may transmit information to the network indicating application of the virtualization for the transmission.

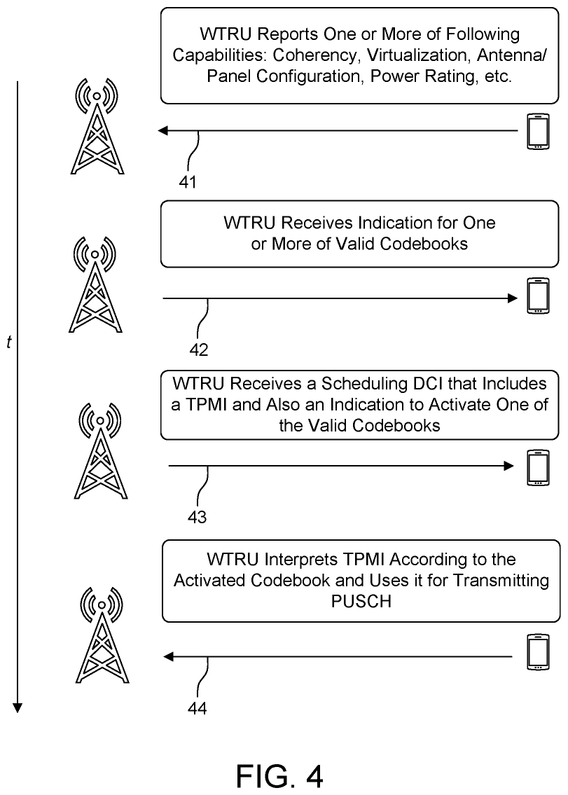

FIG. 6 is a diagram illustrating an example method 600 for codebook determination. The method may be implemented in a WTRU. As shown at 610, the WTRU may transmit capability information indicating a capability of the WTRU to support a plurality of codebooks for uplink precoding. As shown at 620, the WTRU may receive configuration information indicating one or more codebooks of the plurality of codebooks to be used for uplink transmissions. As shown at 630, the WTRU may receive grant information for an uplink transmission. As shown at 640, the WTRU may transmit the uplink transmission based on a codebook of the one or more codebooks.

In various embodiments, the capability information may indicate any of an antenna structure, a coherence capability, and a virtualization capability. In various embodiments, the antenna structure may be any of a cross-polarized array, an array of uniform linear array and a single uniform line array.

In various embodiments, the capability information may indicate any of a number of dimensions for uplink precoder generation, a number of antenna panels, a number of antenna ports, a level of regularity among the antenna ports, etc.

In various embodiments, the capability information may indicate more than one coherence capability. For example, the capability information may indicate a first coherence capability and a second coherence capability. In various embodiments, the first coherence capability may be associated with usage of a first parameter of the WTRU. In various embodiments, the second coherence capability may be associated with usage of a second parameter of the WTRU. In various embodiments, the first parameter of the WTRU may be any of a first codebook, a first antenna panel and a first codeword. In various embodiments, the second parameter of the WTRU may be any of a second codebook, a second antenna panel and a second codeword.

In various embodiments, the capability information may indicate any of (i) a vertical dimension of an antenna array, (ii) a horizontal dimension of the antenna array, (iii) a number of polarizations, (iv) one or more virtualization configurations, (v) a dynamic virtualization switching capability, (vi) a panel index per virtualization configuration, a support for Kronecker-based codebook.

In various embodiments, the one or more codebooks of the plurality of codebooks may be to be used for interpreting a TPMI.

In various embodiments, the WTRU may receive first information indicating the codebook of the one or more codebooks to be activated for the uplink transmissions (not shown).

In various embodiments, the grant information may indicate the codebook of the one or more codebooks to be activated for the uplink transmission.

In various embodiments, the WTRU may receive second information indicating the plurality of codebooks for uplink precoding (not shown).

In various embodiments, the uplink transmission may be transmitted with more than one codeword.

In various embodiments, antennas may be grouped in subsets of antennas.

In various embodiments, the capability information may indicate the subsets of antennas.

In various embodiments, the capability information may indicate any of a number of the subsets of antennas and a number of antennas per subset of antennas.

In various embodiments, the uplink transmission may be transmitted using more than one of the subsets of antennas.

In various embodiments, third information indicating one or more sets of transmission configuration parameters may be received (not shown).

In various embodiments, the third information may indicate more than one set of transmission configuration parameters. In various embodiments, each set of transmission configuration parameters may be associated with at least one subset of antennas.

In various embodiments, the third information may indicate a first set of transmission configuration parameters and a second set of transmission configuration parameters. The second set of transmission configuration parameters may be conditioned on the first set of transmission configuration parameters.

In various embodiments, the third information may indicate a single set of transmission configuration parameters. In various embodiments, the single set of transmission configuration parameters may be to be applied to a single subset of antennas. In various embodiments, the single set of transmission configuration parameters may be to be applied to different subsets of antennas for different uplink transmissions. In various embodiments, the single set of transmission configuration parameters may be applied to all the subsets of antennas for the uplink transmission.

In various embodiments, the third information may indicate an uplink transmission rank, and the grant information may indicate any of a precoding and a beam associated with the indicated uplink transmission rank.

In various embodiments, a set of transmission configuration parameters may include any of a transmission rank, a precoding indication and a beam indication.

In various embodiments, the third information may be included in any of the configuration information and the grant information.

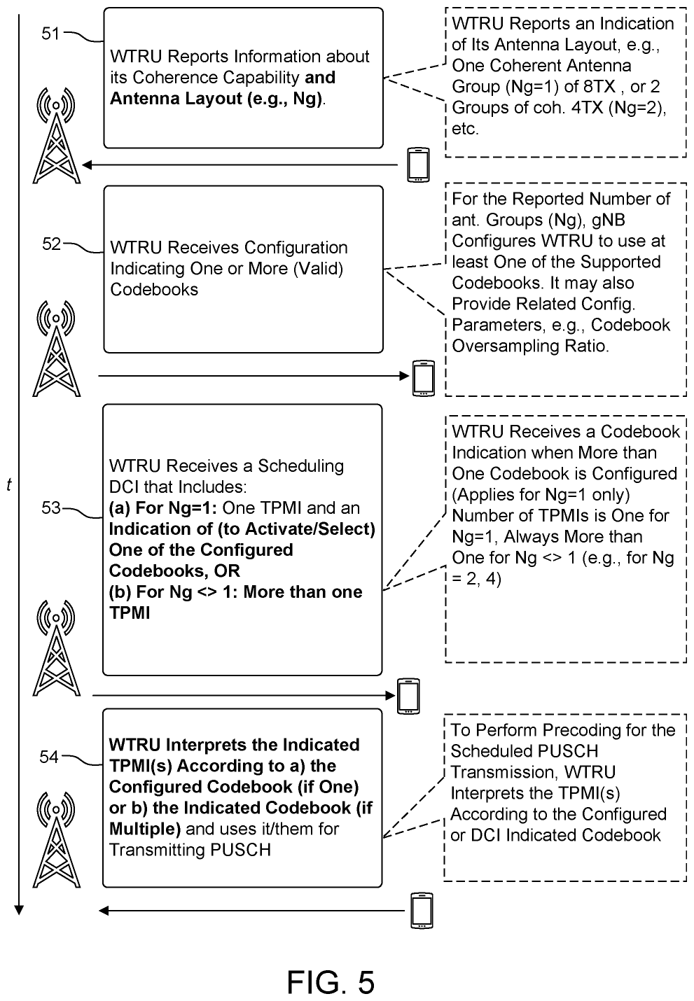

FIG. 7 is a diagram illustrating an example method 700 for codebook and precoding determination by a WTRU based on a number of antenna groups. The method 700 may be implemented in a WTRU. As shown at 710, the WTRU may transmit capability information indicating a number of groups of antennas. As shown at 720, the WTRU may receive configuration information indicating one codebook or more than one codebook (e.g., based on the transmitted capability information). As shown at 730, the WTRU may receive scheduling information for a transmission. The scheduling information may indicate (a) a codebook indicator and one TPMI or (b) a plurality of TPMIs, wherein each of the plurality of TPMIs may be associated with one of the groups of antennas. As shown at 740, the WTRU may determine a codebook of the one codebook, or the more than one codebook based on any of the scheduling information and the configuration information. As shown at 750, the WTRU may transmit (e.g., perform) the transmission based on the determined codebook and (a) the one TPMI or (b) the plurality of TPMIs.

In various embodiments, the configuration information may indicate more than one codebook, and the codebook indicator may indicate the codebook of the more than one codebook.

In various embodiments, the configuration information may indicate the one codebook, the codebook may be determined as the one codebook and the plurality of TPMIs may be associated with the one codebook.

In various embodiments, a group of antennas of the groups of antennas may be associated with a coherence capability.

In various embodiments, the coherence capability associated with the group of antennas may be indicated in the capability information implicitly or explicitly.

In various embodiments, the transmission may comprise an uplink transmission.

In various embodiments, the uplink transmission may comprise a physical uplink shared channel transmission.

In various embodiments, in a case where the number of groups of antennas is one, the scheduling information may indicate the one TPMI. The scheduling information may indicate the one TPMI based on (e.g., on condition that) the number of groups of antennas being one.

In various embodiments, in a case where the number of groups of antennas is one, the scheduling information may indicate the one codebook. The scheduling information may indicate the one codebook based on (e.g., on condition that) the number of groups of antennas being one.

In various embodiments, in a case where the number of groups of antennas is one, the configuration information may indicate more than one codebook. The configuration information may indicate more than one codebook based on (e.g., on condition that) the number of groups of antennas being one.

In various embodiments, in a case where the number of groups of antennas is greater than one, the scheduling information may indicate the plurality of TPMIs. The scheduling information may indicate the plurality of TPMIs based on (e.g., on condition that) the number of groups of antennas being greater than one.

In various embodiments, in a case where the number of groups of antennas is greater than one, the configuration information may indicate the one codebook (e.g., as single configured codebook). The configuration information may indicate the one codebook based on (e.g., on condition that) the number of groups of antennas being greater than one.

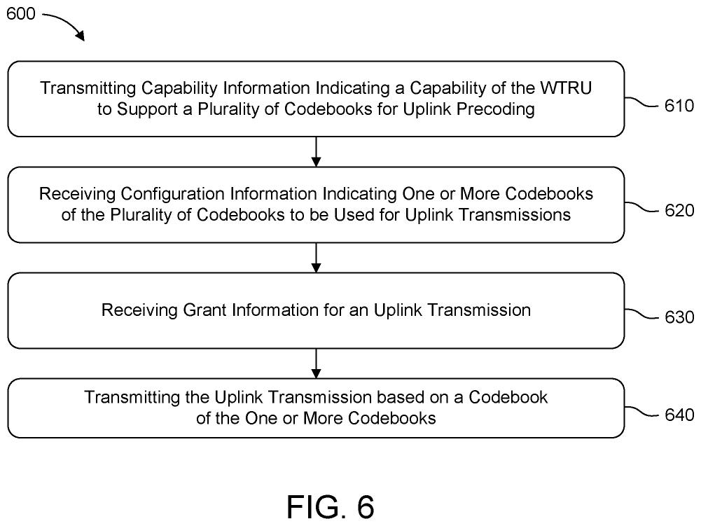

FIG. 8 is a diagram illustrating an example method 800 for codebook and precoding determination by a WTRU with a single antenna group. The method 800 may be implemented in a WTRU. As shown at 810, the WTRU may transmit capability information indicating a single group of antennas. As shown at 820, the WTRU may receive configuration information indicating more than one codebook (e.g., based on the transmitted capability information). As shown at 830, the WTRU may receive scheduling information for a transmission. The scheduling information may indicate a codebook of the more than one codebook and a TPMI. As shown at 840, the WTRU may transmit (e.g., perform) the transmission based on the (e.g., indicated) codebook and the (e.g., indicated) TPMI.

In various embodiments, the single group of antennas may be associated with a coherence capability.

In various embodiments, the coherence capability may be indicated in the capability information implicitly or explicitly.

In various embodiments, each codebook of the more than one codebook may be associated with support of the single group of antennas.

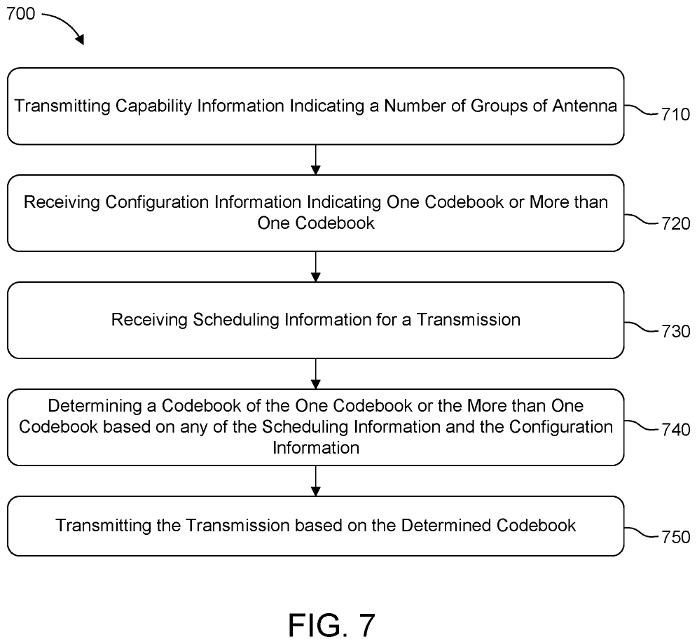

FIG. 9 is a diagram illustrating an example method 900 for codebook and precoding determination by a WTRU with more than one antenna group. The method 900 may be implemented in a WTRU. As shown at 910, the WTRU may transmit capability information indicating a number of groups of antennas, wherein the number may be greater than one. As shown at 920, the WTRU may receive configuration information indicating a codebook (e.g., based on the transmitted capability information). As shown at 930, the WTRU may receive scheduling information for a transmission. The scheduling information may indicate a plurality of TPMIs, wherein each of the plurality of TPMIs may be associated with a group of antennas (e.g., one of the groups of antennas). As shown at 940, the WTRU may transmit (e.g., perform) the transmission based on the (e.g., indicated) codebook and the (e.g., indicated) plurality of TPMIs.

In various embodiments, a group of antennas of the groups of antennas may be associated with a coherence capability.

In various embodiments, the coherence capability may be indicated in the capability information implicitly or explicitly.

In various embodiments, the (e.g., indicated) codebook may be associated with support for more than one of the groups of antennas.

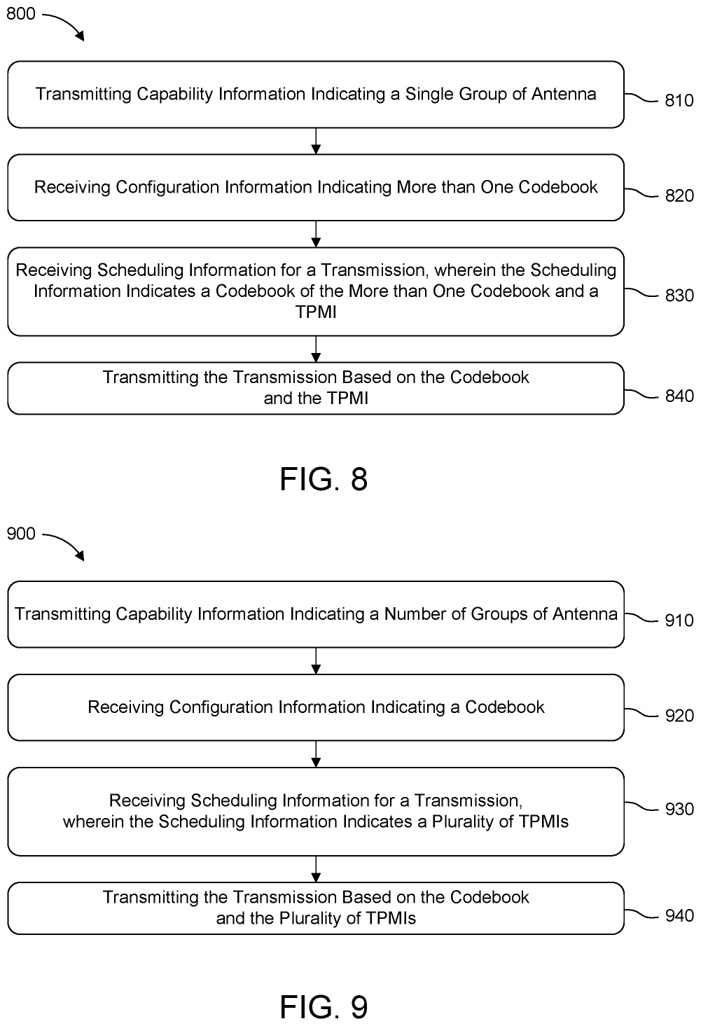

FIG. 10 is a diagram illustrating an example method 1000 for determining precoding information and transmission rank information based on receiving configuration information in separate transmissions. The method 1000 may be implemented in a WTRU. As shown at 1010, the WTRU may receive first (e.g., configuration) information indicating one or more transmission ranks. As shown at 1020, the WTRU may receive second (e.g., scheduling) information for a transmission, wherein the second (e.g., scheduling) information may comprise precoding information associated with the indicated one or more transmission ranks, and wherein the first (e.g., configuration) information and the second (e.g., scheduling) information may be received in separate transmissions. As shown at 1030 the WTRU may perform the transmission based on the precoding information and on the associated indicated one or more transmission ranks.

In various embodiments, the one or more transmission ranks may comprise a maximum transmission rank.

In various embodiments, the first (e.g., configuration) information may indicate one or more modulation and coding schemes, and the transmission may be performed in accordance with the one or more modulation and coding schemes.

In various embodiments, the first (e.g., configuration) information may indicate one or more antenna ports, and the transmission may be performed in accordance with the one or more antenna ports.

In various embodiments, the first (e.g., configuration) information may indicate one or more codebooks, and the transmission may be performed in accordance with the one or more codebooks.

In various embodiments, the second (e.g., scheduling) information may indicate one or more TPMIs associated with the indicated one or more transmission ranks, and the transmission may be performed in accordance with the one or more TPMIs.

In various embodiments, the first (e.g., configuration) information may indicate a codebook, and the second (e.g., scheduling) information may indicate a plurality of TPMIs associated with the codebook and associated with the indicated one or more transmission ranks.

The transmission may be performed in accordance with the indicated codebook and the indicated plurality of TPMIs.

In various embodiments, the first (e.g., configuration) information may indicate a plurality of codebooks and the scheduling information may indicate a codebook of the indicated plurality of codebooks. The transmission may be performed in accordance with the indicated codebook.

In various embodiments, the first (e.g., configuration) information may be received in any of a RRC message and MAC CE.

In various embodiments, the second (e.g., scheduling) information may be received in downlink control information.

In various embodiments, the transmission may be an uplink transmission.

In various embodiments, the uplink transmission may be any of PUSCH and a PUCCH transmission.

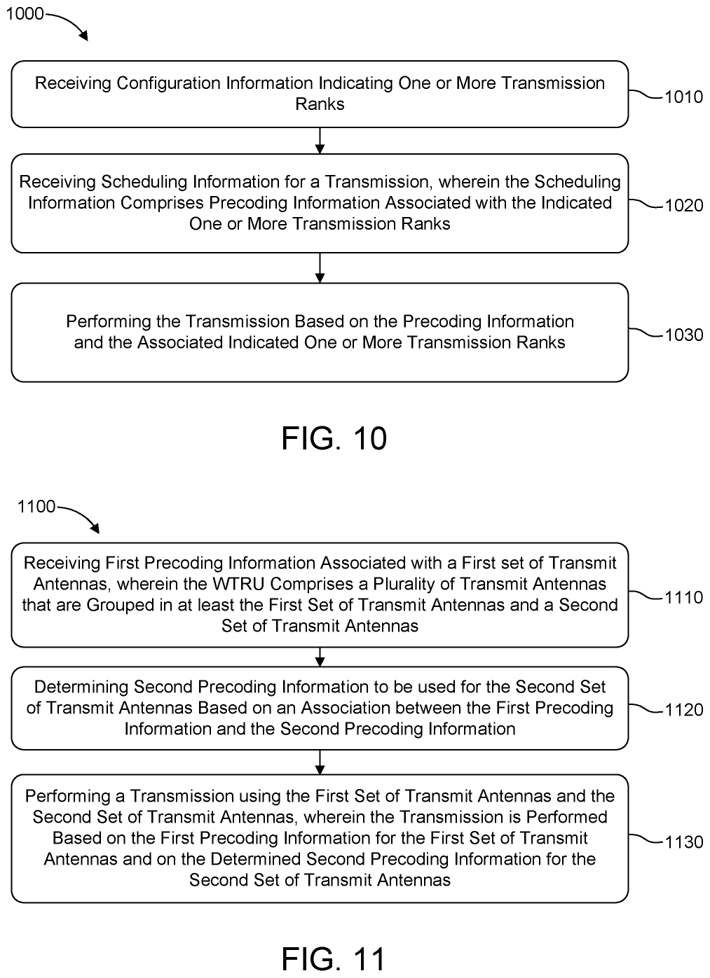

FIG. 11 is a diagram illustrating an example method 1100 for reducing the channel state information overhead for WTRUs with multiple sets of transmit antennas. The method 1100 may be implemented in a WTRU. As shown at 1110, the WTRU may receive first precoding information associated with (e.g., to apply to) a first set (e.g., group) of transmit antennas, wherein the WTRU may comprise a plurality of transmit antennas that may be grouped in at least the first set (e.g., group) of transmit antennas and a second set (e.g., group) of transmit antennas. As shown at 1120, the WTRU may determine second precoding information to be used for the second set (e.g., group) of transmit antennas based on an association between the first precoding information and the second precoding information. As shown at 1130, the WTRU may perform a transmission using the first set (e.g., group) of transmit antennas and the second set (e.g., group) of transmit antennas, wherein the transmission may be performed based on the first precoding information for the first set (e.g., group) of transmit antennas and on the determined second precoding information for the second set (e.g., group) of transmit antennas.

In various embodiments, the WTRU may transmit capability information indicating the first set (e.g., group) of transmit antennas and the second set (e.g., group) of transmit antennas (not shown).

In various embodiments, the capability information may indicate any of a number of sets (e.g., groups) of transmit antennas, a number of transmit antennas per set (e.g., group), a coherence capability, a power capability, and a virtualization capability.

In various embodiments, the first precoding information may indicate a first TPMI.

In various embodiments, the association between the first precoding information and the second precoding information may be preconfigured in the WTRU.

In various embodiments, the WTRU may receive association information indicating the association between the first precoding information and the second precoding information (not shown).

In various embodiments, the first precoding information may indicate a first TPMI, and the association information may indicate that a second TPMI may be associated with the first TPMI.

In various embodiments, determining the precoding information may comprise determining the second TPMI based on the association information.

In various embodiments, the association information may indicate, for each TPMI of a codebook an associated TPMI.

In various embodiments, the association between the first precoding information and the second precoding information may be based on channel qualities associated with previous transmissions performed based on the first precoding information and the second precoding information.

In various embodiments, the transmission may be an uplink transmission.

In various embodiments, the uplink transmission may be any of PUSCH and a PUCCH transmission.

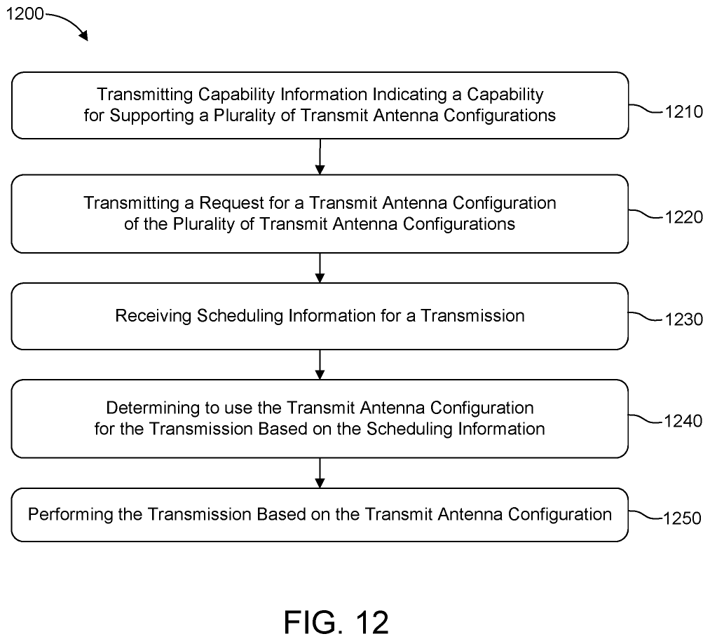

FIG. 12 is a diagram illustrating an example method 1200 for enabling a dynamic transmit antenna configuration. The method 1200 may be implemented in a WTRU. As shown at 1210, the WTRU may transmit capability information indicating a capability for supporting a plurality of transmit antenna configurations. As shown at 1220, the WTRU may transmit a request for a transmit antenna configuration of the plurality of transmit antenna configurations. As shown at 1230, the WTRU may receive scheduling information for a transmission. As shown at 1240, the WTRU may determine to use the requested transmit antenna configuration for the transmission based on the scheduling information. As shown at 1250, the WTRU may perform the transmission based on the requested transmit antenna configuration.

In various embodiments, the plurality of transmit antenna configurations may comprise different transmit antenna configurations with different numbers of transmit antennas.

In various embodiments, the plurality of transmit antenna configurations may comprise different transmit antenna configurations to be used for different transmissions on different channels of different expected reliabilities.

In various embodiments, the capability information may indicate a virtualization capability for supporting the plurality of transmit antenna configurations.

In various embodiments, the capability information may indicate a maximum transmit power for each transmit antenna configuration of the plurality of transmit antenna configurations.

In various embodiments, the request for a transmit antenna configuration may be transmitted for obtaining an operational objective.

In various embodiments, the operational objective may comprise any of a higher reliability and a lower power consumption.

In various embodiments, the scheduling information may indicate the requested transmit antenna configuration associated with the transmission.

In various embodiments, the scheduling information may indicate one or more antenna ports associated with the transmission.

In various embodiments, it may be determined to use the requested transmit antenna configuration for the transmission based on the indicated one or more antenna ports associated with the transmission.

In various embodiments, the transmission may be an uplink transmission.

In various embodiments, the transmit antenna configuration may comprise (e.g., be associated with) eight transmit antennas, and the transmission may be any of a PUCCH transmission, an SRS transmission and a PUSCH transmission comprising uplink control information.

In various embodiments, the transmit antenna configuration may comprise (e.g., be associated with) four transmit antennas, and the transmission may be a PUSCH transmission without uplink control information.

In various embodiments, the scheduling information may be received in down link control information.

While not explicitly described, the present embodiments may be employed in any combination or sub-combination. For example, the present principles are not limited to the described variants, and any arrangement of variants and embodiments can be used.

Besides, any characteristic, variant or embodiment described for a method is compatible with an apparatus device comprising means for processing the disclosed method, with a device comprising circuitry, including any of a transmitter, a receiver, a processor, a processor and a memory configured to process the disclosed method, with a computer program product comprising program code instructions and with a non-transitory computer-readable storage medium storing program instructions.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶6 or means-plus-function claim format, and any claim without the terms “means for” is not so intended.

1-21. (canceled)

22. A method implemented in a wireless transmit/receive unit (WTRU), the method comprising:
transmitting capability information indicating a number of antenna port groups;
receiving configuration information indicating at least one codebook;
receiving scheduling information for a transmission, wherein the scheduling information comprises precoding information associated with a number of precoders, wherein the number of antenna port groups is equal to the number of precoders, and wherein each precoder is associated with a different antenna port group;
determining the precoders for the antenna port groups based on the at least one codebook and the precoding information, wherein a precoder is determined for each antenna port group; and
transmitting the transmission using the antenna port groups and the determined precoders.

23. The method of claim 22, wherein antenna ports within an antenna port group are fully coherent.

24. The method of claim 22, wherein the antenna port groups are antenna panels.

25. The method of claim 22, wherein the precoding information comprises a plurality of transmit precoding matrix indicators (TPMIs).

26. The method of claim 22, wherein transmitting the transmission comprises using each precoder for transmission of a different codeword.

27. The method of claim 22, wherein each precoder corresponds to a different codebook.

28. The method of claim 22, wherein the antenna port groups are associated with a coherence capability.

29. The method of claim 28, wherein the coherence capability associated with the antenna port groups is indicated in the capability information implicitly or explicitly.

30. The method of claim 22, wherein the transmission is an uplink transmission.

31. The method of claim 30, wherein the uplink transmission is a physical uplink shared channel transmission.

32. A wireless transmit/receive unit (WTRU) comprising circuitry, including any of a transmitter, a receiver, a processor, and a memory, configured to:
transmit capability information indicating a number of antenna port groups;
receive configuration information indicating at least one codebook;
receive scheduling information for a transmission, wherein the scheduling information comprises precoding information associated with a number of precoders, wherein the number of antenna port groups is equal to the number of precoders, and wherein each precoder is associated with a different antenna port group;
determine the precoders for the antenna port groups based on the at least one codebook and the precoding information, wherein a precoder is determined for each antenna port group; and
transmit the transmission using the antenna port groups and the determined precoders.

33. The WTRU of claim 32, wherein antenna ports within an antenna port group are fully coherent.

34. The WTRU of claim 32, wherein the antenna port groups are antenna panels.

35. The WTRU of claim 32, wherein the precoding information comprises a plurality of transmit precoding matrix indicators (TPMIs).

36. The WTRU of claim 32, wherein the WTRU being configured to transmit the transmission comprises the WTRU being configured to use each precoder for transmission of a different codeword.

37. The WTRU of claim 32, wherein each precoder corresponds to a different codebook.

38. The WTRU of claim 32, wherein the antenna port groups are associated with a coherence capability.

39. The WTRU of claim 38, wherein the coherence capability associated with the antenna port groups is indicated in the capability information implicitly or explicitly.

40. The WTRU of claim 32, wherein the transmission is an uplink transmission.

41. The WTRU of claim 40, wherein the uplink transmission is a physical uplink shared channel transmission.
